(19) United States
(12) Patent Application Publication
(10) Pub. No.: US 2026/0115842 A1
(43) Pub. Date: Apr. 30, 2026

(54) HEAT TREATMENT METHOD FOR WELDED JOINT PART OF FLASH-BUTT-WELDED RAIL AND PRODUCTION METHOD FOR FLASH-BUTT-WELDED RAIL

(71) Applicant: NIPPON STEEL CORPORATION, Tokyo (JP)

(72) Inventors: Masaharu UEDA, Tokyo (JP); Kenji SAITA, Tokyo (JP); Takuya TANAHASHI, Tokyo (JP)

(73) Assignee: NIPPON STEEL CORPORATION, Tokyo (JP)

(21) Appl. No.: 19/120,535

(22) PCT Filed: Dec. 12, 2022
(86) PCT No.: PCT/JP2022/045647

§ 371 Date: Apr. 11, 2025

(51) Int. Cl. B23K 37/003; B23K 11/04; B23K 31/02

(52) U.S. Cl. CPC B23K 37/003; B23K 11/04; B23K 31/02

(57) ABSTRACT

In a heat treatment method for a welded joint part of a flash-butt-welded rail, first accelerated cooling is started when temperatures of a head top corner-side outer surface and a web outer surface are in a range of 700° C. or higher, in the first accelerated cooling, an average cooling rate in a temperature range of 750° C. to 600° C. of the head top corner-side outer surface is set to 1.0 to 3.5° C./sec, an average cooling rate in a temperature range of 750° C. to 600° C. of the web outer surface is set to 1.0 to 4.0° C./sec, the first accelerated cooling is stopped when the temperature of the head top corner-side outer surface and the temperature of the web outer surface are in a range of 500° C. to 600° C., and heating is started within 300 seconds after the stop of the first accelerated cooling.

### TECHNICAL FIELD

The present invention relates to a heat treatment method for a welded joint part of a flash-butt-welded rail and a production method for a flash-butt-welded rail.

### BACKGROUND ART

Flash butt welding is widely used as a welding method for rails. Flash butt welding is known to have advantages such as the ability to be automated, having high quality stability, and a short welding time.

Flash butt welding is a technique of joining rails together by melting end surfaces of the rails by heating and then pressing the melted surfaces under pressure. During flash butt welding, the rail is heated from room temperature to a maximum of near the melting point and then cooled. Therefore, the flash butt welding causes changes in microstructure and hardness of the rail. Portions where metallurgical properties, mechanical properties, and the like change due to the heat of welding as described above are called heat-affected zones (HAZ).

In the HAZ, a region (hereinafter, referred to as “re-y portion”) in which rail steel is austenitized by being reheated to an A1 point or higher during welding and is then subjected to pearlitic transformation, and a region (hereinafter, referred to as “tempered portion”) in which the rail steel is partially austenitized as a result of the vicinity of the re-y portion being reheated to near the A1 point and is then subjected to the decomposition and spheroidization of a pearlite structure, are formed. Lengths of the regions including the re-y portion and tempered portion in a longitudinal direction of the rail are collectively referred to as a HAZ width (see FIG. 3B). The HAZ has problems of wear resistance due to hardness and breakage resistance due to martensite.

First, the problem of hardness will be described. In the re-y portion, pearlitic transformation occurs during natural cooling after welding. However, a cooling rate of a head top surface that has been naturally cooled is slower than a cooling rate of the head top surface during the rail production. This is because the head top surface is subjected to accelerated cooling in order to secure the hardness during the production of the rail. Therefore, the hardness of the re-y portion is lower than that of a rail base material. Furthermore, in the tempered portion, the hardness is lower than that of the rail base material due to the decomposition or spheroidization of the pearlite structure.

As described above, in a welded joint part of the welded rail, the hardness of the head top surface is likely to decrease due to a microstructural change caused by reheating. When the hardness of the welded joint part decreases, in a freight railway with a harsh usage environment, the wear of the head top surface of the welded joint part is promoted by the passage of wheels. As a result, unevenness due to wear occurs in the welded joint part, and an excessive load is applied to the welded joint part when a train is running, which tends to shorten a service life of the rail.

Next, the problem of martensite will be described. Cooling rates of an inside of a head portion and a web portion in the re-y portion of the welded rail during natural cooling after welding are faster than the cooling rates of the inside of the head portion and the web portion during the rail production. In general, during the production of a rail, an accelerated cooling rate of the rail is appropriately controlled in order to avoid the generation of martensite. On the other hand, a cooling rate of the welded Joint part of the welded rail is increased compared to the accelerated cooling rate during the rail production because the temperature rapidly drops after the welding is completed due to heat transfer caused by a temperature difference between the welded joint part and the base material portion. Therefore, during cooling after the end of welding, pearlitic transformation is not completed in the welded joint part, and a martensite structure with low toughness is likely to be generated. When a martensite structure is generated in the pearlite structure, there is a problem that a rail is likely to be broken in a freight railway with a harsh usage environment. Therefore, the amount of the martensite structure in the welded joint part is regulated by rail standards or the like (for example, CN SPECIFICATION FOR THE MANUFACTURE OF STEEL RAIL, 12-16D).

As described above, in the welded joint part of the welded rail, (1) there was a problem in that the wear of the head top portion was promoted due to a decrease in hardness on the head top surface, and (2) there was a problem in that the rail was broken due to the generation of a martensite structure having low toughness in the inside of the head portion and the web portion.

In order to solve such a problem, there has been a demand for the development of a heat treatment method for securing the hardness of the head top surface of the rail in the welded joint part in the flash butt welding and suppressing the martensite structure in the inside of the head portion of the rail and the web portion.

For example, the following techniques have been proposed to secure the hardness of the HAZ.

Patent Document 1 describes a heat treatment method in which a rail welded joint part after welding is reheated to prevent a decrease in hardness and bending of a rail head top surface of a re-y portion in the rail welded joint part, and then a base portion is subjected to controlled cooling while a rail head portion is subjected to accelerated cooling.

Patent Document 2 describes a flash butt welding method for realizing a rail welded joint in which, in flash butt welding of rails, in order to reduce a region of a tempered portion on a head top surface, a later flash speed during welding is set to 2.1 mm/sec or faster, a HAZ width is set to 27 mm or less, and a length of the tempered portion in a rail longitudinal direction is set to 10 mm or less.

In addition, in the flash butt welding of the rails, for example, the following heat treatment technologies have been proposed in order to control a microstructure of a welded joint part.

Patent Document 3 discloses that in flash butt welding of rails, in order to prevent the generation of pro-eutectoid cementite structures generated in a welded joint part heated to a range of 800° C. to 900° C. and improve toughness of the welded joint part, a head portion and/or a base portion of a rail is subjected to accelerated cooling from a temperature range of 750° C. or higher at a cooling rate of 1 to 10° C./sec, the accelerated cooling is stopped at the time when a temperature of the head portion and/or the base portion of the rail reaches 680° C. to 550° C., and thereafter, natural cooling or slow cooling is performed so that the temperature of the head portion and/or the base portion of the rail does not exceed 680° C.

In addition, Patent Document 4 discloses that in a rail welded joint part, in order to suppress the occurrence of brittle fracture originating from a base portion, a surface of the base portion is heated to higher than 600° C. and 800° C. or lower by induction heating and then cooled.

In addition, in flash butt welding, for example, the following heat treatment technologies have been proposed in order to control a microstructure of a welded joint part.

Patent Document 5 discloses that in order to improve a microstructure in production a steel component having a flash-butt-welded joint part, a temperature of the welded joint part is raised or the temperature of the welded joint part is maintained at a high temperature and the welded joint part is further cooled to a temperature higher than a martensite start temperature.

Patent Document 6 discloses that in order to reduce temperature variation in a width direction of a flash-butt-welded part of a thin plate (steel strip), energization heating is performed after welding, and the welded part is subjected to a post-heat treatment.

### CITATION LIST

### Patent Documents

Patent Document 1: Japanese Unexamined Patent Application, First Publication No. H3-104824
Patent Document 2: PCT International Publication No. WO2011/052562
Patent Document 3: Japanese Unexamined Patent Application, First Publication No. 2004-43862
Patent Document 4: PCT International Publication No. WO2015/156243
Patent Document 5: Published Japanese Translation No. 2015-510452 of the PCT International Publication
Patent Document 6: Japanese Unexamined Patent Application, First Publication No. H8-118034

### SUMMARY OF INVENTION

### Technical Problem

In the technology described in Patent Document 1, it is possible to suppress a decrease in hardness of the head top surface of the re-y portion. However, it is difficult to prevent the generation of a coarse martensite structure that significantly decreases the toughness in the inside of the head portion and the web portion of the re-y portion, and there is a problem that the breakage resistance of the rail is not improved.

In the technology described in Patent Document 2, the length of the tempered portion on the head top surface in the rail longitudinal direction is reduced by reducing the HAZ width of a welded joint part of a welded rail, but this effect is not observed in a region of a re-γ portion. Therefore, the hardness of a pearlite structure decreases. Therefore, unevenness occurs due to wear of a head top portion of the re-γ portion, and there is a problem in that a service life of the rail cannot be fundamentally improved. In addition, when the HAZ width is reduced, a cooling rate of the welded joint part increased, and the generation of a coarse martensite structure that significantly reduces the toughness in an inside of a head portion and a web portion of the welded joint part increases. As a result, there is a problem in that breakage resistance of the rail further decreases.

The heat treatment method of Patent Document 3 is intended to prevent the generation of the pro-eutectoid cementite structures in a HAZ of the welded joint part of a welded rail, and is not intended to control the decrease in hardness on a head top surface of the welded joint part or the generation of a martensite structure generated in the inside of the head portion and the web portion.

The heat treatment method of Patent Document 4 is intended to improve toughness of the base portion of the welded joint part of a welded rail, and is not intended to control the decrease in hardness on a head top surface of the welded joint part or the generation of a martensite structure generated in an inside of a head portion and a web portion.

The heat treatment method of Patent Document 5 is for stably forming a pearlite structure or a bainite structure in order to secure hardness or toughness of a welded joint part, that is, for suppressing the generation of a martensite structure. However, specific heat treatment conditions are not disclosed in Patent Document 5. In addition, a method for suppressing the generation of internal martensite in a large structure such as a rail and a HAZ reduction technology are not disclosed in Patent Document 5.

The heat treatment method of Patent Document 6 is a method for reducing the temperature variation in the width direction, and is not a method for controlling the generation of a martensite structure as described above.

In addition, Patent Document 6 does not disclose specific heat treatment conditions.

The present invention has been made in view of the above-described problems, and an object thereof is to provide a heat treatment method and a production method for a flash-butt-welded rail capable of controlling a hardness of a head top surface of a welded joint part in a flash-butt-welded rail, preventing the generation of a martensite structure in an inside of a head portion and a web portion at the same time, and improving wear resistance and breakage resistance. Preferably, another object of the present invention is to provide a heat treatment method and a production method for a flash-butt-welded rail capable of satisfying extremely strict wear resistance and breakage resistance required for a flash-butt-welded rail of a rail of a freight railway with a harsh track environment.

### Solution to Problem

The gist of the present invention is as follows.
(1) A heat treatment method for a welded joint part of a flash-butt-welded rail according to an aspect of the present invention includes: performing, after flash butt welding in a flash-butt-welded rail having a welded joint part is ended, first accelerated cooling on the welded joint part; stopping the first accelerated cooling; heating the welded joint part; and holding a temperature of the welded joint part, in which the first accelerated cooling is started when temperatures of a head top corner-side outer surface and a web outer surface in a weld center of the welded joint part are in a range of 700° C. or higher, in the first accelerated cooling, an average cooling rate in a temperature range of 750° C. to 600° C. of the head top corner-side outer surface in the weld center of the welded joint part is set to 1.0 to 3.5° C./sec, in the first accelerated cooling, an average cooling rate in a temperature range of 750° C. to 600° C. of the web outer surface in the weld center of the welded joint part is set to 1.0 to 4.0° C./sec, the first accelerated cooling is stopped when the temperature of the head top corner-side outer surface and the temperature of the web outer surface in the weld center of the welded joint part are in a range of 500° C. to 600° C., the heating is started within 300 seconds after the stop of the first accelerated cooling, in the heating, an average heating rate of the head top corner-side outer surface and an average heating rate of the web outer surface in the weld center of the welded joint part are set to 0.5 to 2.0° C./sec, and in the holding, the temperature of the head top corner-side outer surface and the temperature of the web outer surface in the weld center of the welded joint part are held in a range of 620° C. to 670° C. for 30 to 180 seconds.
(2) Preferably, the heat treatment method for a welded joint part of a flash-butt-welded rail according to (1), further includes: performing second accelerated cooling on the welded joint part such that the head top corner-side outer surface and the web outer surface in the weld center of the welded joint part are cooled to 200° C. or lower at an average cooling rate of 0.5° C./sec or faster after the holding of the temperature of the welded joint part.
(3) A production method for a flash-butt-welded rail according to another aspect of the present invention includes: performing flash butt welding on rails to obtain a flash-butt-welded rail; removing burrs from a welded joint part of the flash-butt-welded rail; and performing a heat treatment on the flash-butt-welded rail using the heat treatment method for a welded joint part of a flash-butt-welded rails according to (1) or (2).

### Advantageous Effects of Invention

According to the above aspects of the present invention, it is possible to improve wear resistance and breakage resistance of the welded joint part.

### BRIEF DESCRIPTION OF DRAWINGS

FIG. 1A A flowchart of a heat treatment method for a welded joint part of a flash-butt-welded rail according to the present embodiment.

FIG. 1B A schematic view of heat treatment conditions.

FIG. 2A A cross-sectional view of a welded rail perpendicular to a longitudinal direction and a side view of the welded rail.

FIG. 2B An enlarged cross-sectional view of a head portion of the welded rail.

FIG. 3A A perspective view of a sample cut out from the welded rail so that a longitudinal section is visible.

FIG. 3B A micrograph of a heat-affected zone in the longitudinal section.

FIG. 3C A schematic view of a hardness distribution 5 mm below an outer surface in the longitudinal section immediately below a rail head top outer surface 1111 and a head top outer surface 1211.

FIG. 4 A graph showing a relationship between an accelerated cooling rate of a welded joint part in first accelerated cooling and a difference in hardness (Vickers hardness measured with a load of 10 kg) between the welded joint part and a base material.

FIG. 5 A graph showing a relationship between an accelerated cooling stop temperature in the first accelerated cooling of the welded joint part and the difference in hardness (Vickers hardness measured with a load of 10 kg) between the welded joint part and the base material.

FIG. 6 A graph showing a relationship between the accelerated cooling stop temperature in the first accelerated cooling of the welded joint part and the number of martensite structures generated.

FIG. 7 A graph showing a relationship between a heating start time of the welded joint part and the number of martensite structures generated.

FIG. 8 A graph showing a relationship between a heating rate of the welded joint part and the number of martensite structures generated and a relationship between the heating rate of the welded joint part and a hardness of the head top outer surface.

FIG. 9 A graph showing a relationship between a holding highest temperature of the welded joint part and the number of martensite structures generated, and a relationship between the holding highest temperature of the welded joint part and the hardness of the head top outer surface.

FIG. 10 A graph showing a relationship between a holding time of the welded joint part and the number of martensite structures generated, and a relationship between the holding time of the welded joint part and the hardness of the head top outer surface.

FIG. 11 A graph showing a relationship between a cooling rate after a heating treatment of the welded joint part and the hardness (Vickers hardness measured with a load of 10 kg) of the head top outer surface.

FIG. 12 A graph showing a relationship between a cooling stop temperature after the heating treatment of the welded joint part and the hardness (Vickers hardness measured with a load of 10 kg) of the head top outer surface.

FIG. 13 A flowchart of a production method for a flash-butt-welded rail according to the present embodiment.

FIG. 14 A perspective view of rails and electrodes immediately before the start of flash butt welding in an example of the production method for a flash-butt-welded rail according to the present embodiment.

FIG. 15A A schematic side view of the rails and the electrodes immediately before the start of the flash butt welding in the example of the production method for a flash-butt-welded rail according to the present embodiment.

FIG. 15B A schematic side view of an initial flashing step of the flash butt welding in the example of the production method for a flash-butt-welded rail according to the present embodiment.

FIG. 15C A schematic side view of a preheating step of the flash butt welding in the example of the production method for a flash-butt-welded rail according to the present embodiment.

FIG. 15D A schematic side view of a later flashing step of the flash butt welding in the example of the production method for a flash-butt-welded rail according to the present embodiment.

FIG. 15E A schematic side view of a state immediately after the end of an upsetting step of the flash butt welding in the example of the production method for a flash-butt-welded rail according to the present embodiment.

FIG. 15F A schematic side view of trimming in the example of the production method for a flash-butt-welded rail according to the present embodiment.

FIG. 15G A schematic side view of the first accelerated cooling of the welded joint part in the example of the production method for a flash-butt-welded rail according to the present embodiment.

FIG. 15H A schematic side view of the heating of the welded joint part in the example of the production method for a flash-butt-welded rail according to the present embodiment.

### DESCRIPTION OF EMBODIMENTS

### (1. Heat Treatment Method for Welded Joint Part of Flash-Butt-Welded Rail)

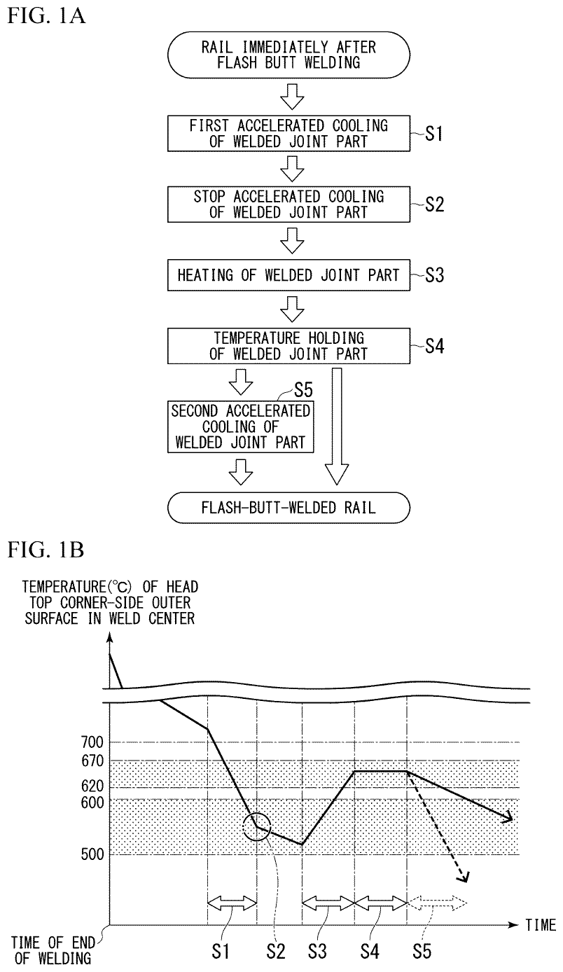

A heat treatment method for a welded joint part of a flash-butt-welded rail according to the present embodiment will be described. The heat treatment method for a welded joint part of a flash-butt-welded rail according to the present embodiment includes, as shown in FIG. 1:
(S1) a step of performing, after flash butt welding in a flash-butt-welded rail 1 having a welded joint part 12 is ended, first accelerated cooling on the welded joint part 12;
(S2) a step of stopping the first accelerated cooling;
(S3) a step of heating the welded joint part 12; and
(S4) a step of holding a temperature of the welded joint part 12. Here,
(a) the first accelerated cooling is started when temperatures of a head top corner-side outer surface 1214 and a web outer surface 1221 in a weld center A of the welded joint part 12 are in a range of 700° C. or higher,
(b) in the first accelerated cooling, an average cooling rate in a temperature range of 750° C. to 600° C. of the head top corner-side outer surface 1214 in the weld center A of the welded joint part 12 is set to 1.0 to 3.5° C./sec,
(c) in the first accelerated cooling, an average cooling rate in a temperature range of 750° C. to 600° C. of the web outer surface 1221 in the weld center A of the welded joint part 12 is set to 1.0 to 4.0° C./sec,
(d) the first accelerated cooling is stopped when the temperature of the head top corner-side outer surface 1214 and the temperature of the web outer surface 1221 in the weld center A of the welded joint part 12 are in a range of 500° C. to 600° C.,
(f) the heating is started within 300 seconds after the stop of the first accelerated cooling,
(g) in the heating, an average heating rate of the head top corner-side outer surface 1214 and an average heating rate of the web outer surface 1221 in the weld center A of the welded joint part 12 are set to 0.5 to 2.0° C./sec, and
in the holding, the temperature of the head top corner-side outer surface 1214 and the temperature of the web outer surface 1221 in the weld center A of the welded joint part 12 are held in a range of (h) 620° C. to 670° C. for (i) 30 to 180 seconds.

The main cause of a decrease in wear resistance of the welded joint part 12 was considered to be a decrease in hardness of the welded joint part 12 after flash butt welding. In addition, the main cause of the deterioration in breakage resistance of the welded joint part 12 was considered to be the generation of martensite in the welded joint part 12 after the flash butt welding. The present inventors found that softening of the welded joint part 12 can be suppressed by performing the first accelerated cooling S1 under predetermined conditions on the welded joint part 12 immediately after the completion of flash butt welding. Furthermore, the present inventors found that the amount of martensite in the welded joint part 12 can be suppressed by performing the heating S3 and the temperature holding S4 on the welded joint part 12 immediately after the stop S2 of the first accelerated cooling S1 under predetermined conditions. Through these heat treatments S1 to S4, the present inventors were able to significantly improve the wear resistance and the breakage resistance of the welded joint part 12.

The heat treatment method for a welded joint part of a flash-butt-welded rail (welded rail) according to the embodiment of the present invention, which is obtained based on the above-described findings, will be described in detail. First, terms used in the present embodiment will be described.

### (Definition of Terms Related to Rails)

The flash-butt-welded rail 1 is a rail obtained by joining rails together by flash butt welding. Hereinafter, the flash-butt-welded rail 1 may be simply referred to as “welded rail 1”.

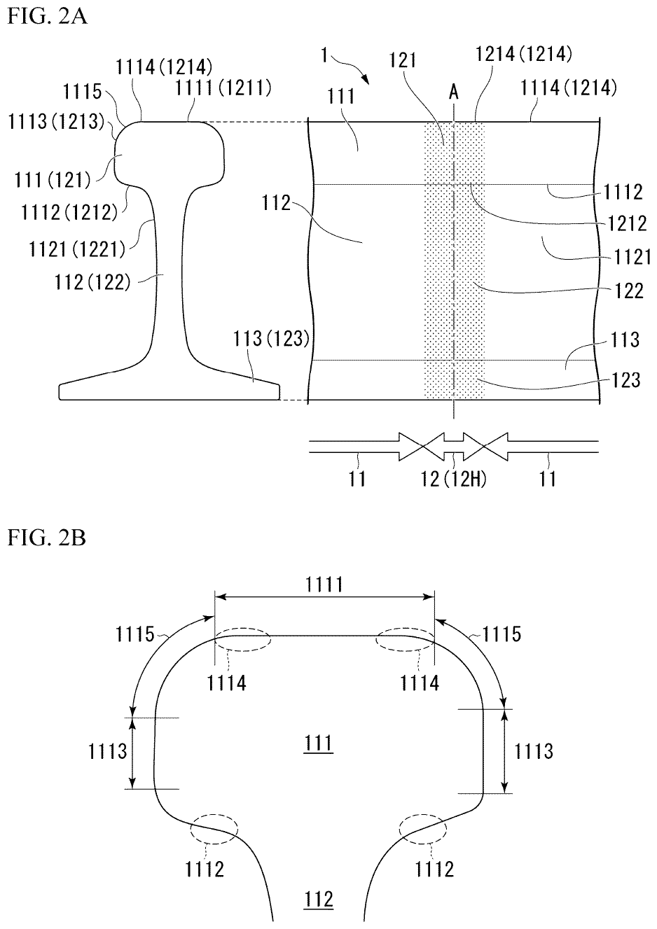

As shown in FIG. 2A, the welded rail 1 includes a plurality of rail portions 11 having a rail head portion 111, a rail web portion 112, and a rail base portion 113, and a welded joint part 12 that joins the rail portions 11. In addition, reference numeral “A” in FIG. 2A denotes a weld center described later. Hereinafter, in a case where “rail” is simply described, this means a rail before welding.

The rail head portion 111 of the rail portion 11 refers to a portion above a narrowed portion at a center of the rail portion 11 in an up-down direction in a cross section perpendicular to a longitudinal direction of the rail portion 11 shown on the left side of FIG. 2A. The rail web portion 112 of the rail portion 11 refers to the narrowed portion at the center of the rail portion 11 in the up-down direction in the cross section of the rail portion 11 shown on the left side of FIG. 2A. Furthermore, the rail base portion 113 of the rail portion 11 refers to a portion below the narrowed portion at the center of the rail portion 11 in the up-down direction in the cross section of the rail portion 11 shown on the left side of FIG. 2A.

In addition, the rail head portion 111 of the rail portion 11 has a head top surface which becomes a top surface of the rail head portion 111 when the welded rail 1 is in use, a head side surface which becomes a side surface of the rail head portion 111, and a corner portion which becomes a rounded corner portion between the head top surface and the head side surface. The head top surface and the corner portion are regions that are repeatedly subjected to a load from wheels, and thus it is preferable to appropriately control these characteristics. In the welded rail 1 according to the present embodiment, as shown in FIGS. 2A and 2B, the head top surface of the rail head portion 111 is referred to as a rail head top outer surface 1111. In the head top surface, an outer surface close to the corner portion of the rail portion 11 is referred to as a rail head top corner-side outer surface 1114. The head side surface of the rail head portion 111 is referred to as a rail head side outer surface 1113. In addition, a narrowed portion of a lower portion of the rail head portion 111 is referred to as a rail fillet portion 1112. As a matter of course, an up-down direction of the welded rail 1 means an up-down direction when the welded rail 1 is used as a track.

In addition, in the rail web portion 112 of the rail portion 11, a surface of a portion which is a middle portion between a center of the rail web portion 112 and a lower end of the rail head portion 111 and is close to the rail fillet portion 1112 is referred to as a rail web outer surface 1121.

The welded joint part 12 is a “welded joint” defined in JIS Z 3001-1:2018, and means a connection portion where members are welded together. In the present embodiment, the member is a rail that is a material of the rail portion 11.

In the welded rail 1, a shape of the welded joint part 12 is substantially the same as a shape of the rail portion 11. Therefore, the welded joint part 12 also has a head portion 121, a web portion 122, and a base portion 123 like the rail portion 11. The head portion 121 of the welded joint part 12 has a head top outer surface 1211, a fillet portion 1212, a head top corner-side outer surface 1214, and a head side outer surface 1213. The web portion 122 of the welded joint part 12 has a web outer surface 1221. Hereinafter, the name of the head portion of the rail portion 11 is referred to as “rail head portion 111”, and the name of the head portion of the welded joint part 12 is simply referred to as “head portion 121”. For other parts, the term “rail” is added in a case where the part is included in the rail portion 11, and the term “rail” is not added in a case where the part is included in the welded joint part 12.

A heat-affected zone (HAZ) 12H is a portion of a base material that has not been melted and has changed in metallurgical properties, mechanical properties, and the like due to heat from welding, cutting, or the like as defined in JIS Z 3001-1:2018. In the present embodiment, the base material is the rail portion 11.

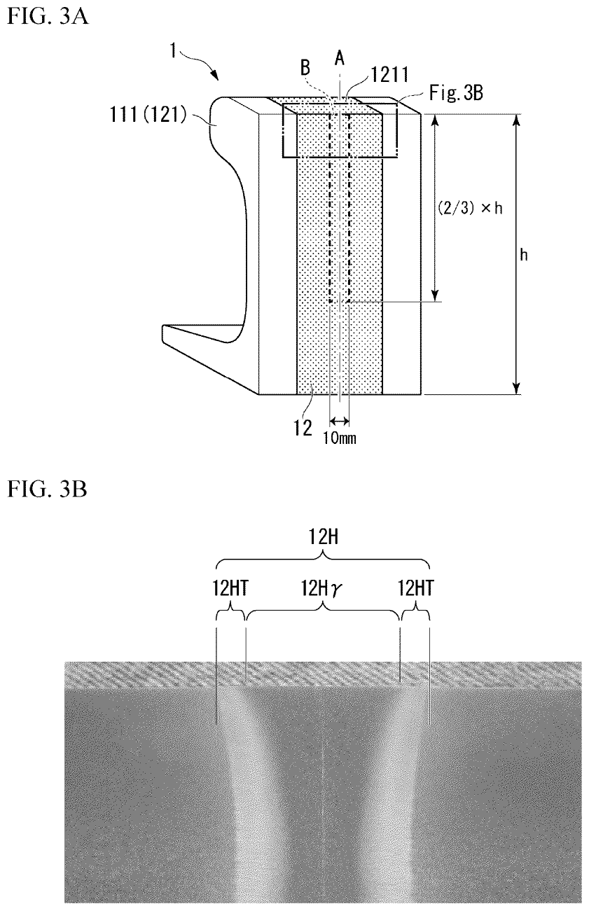

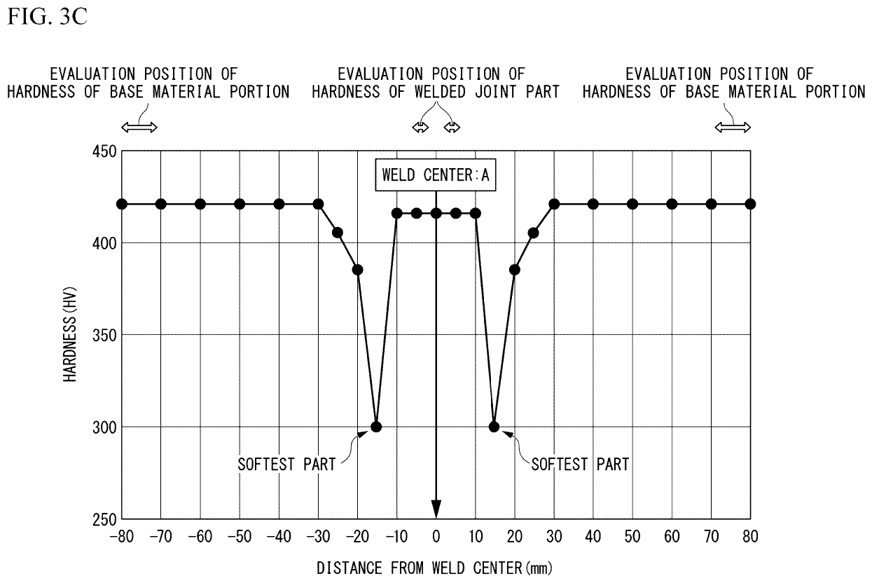

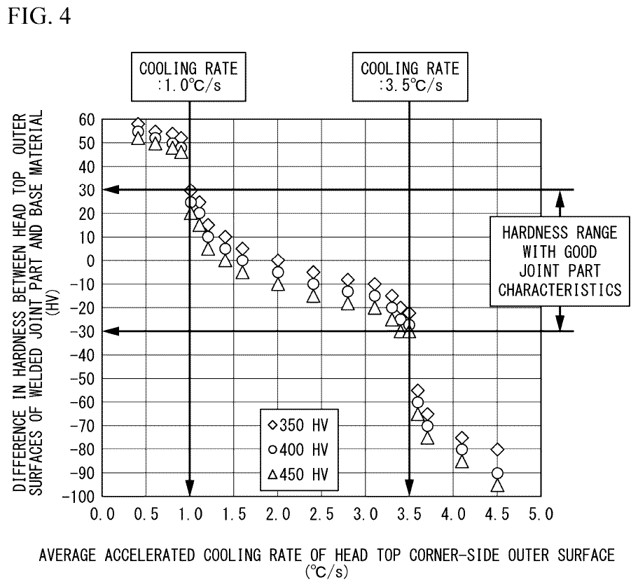

A longitudinal section is a cross section that is parallel to the longitudinal direction and the up-down direction of the welded rail 1 and passes through a center of the welded rail 1 in a width direction. FIGS. 3A and 3B show explanatory views of a longitudinal section of the welded joint part 12.

FIG. 3A is a perspective view of the welded rail 1 cut so that a longitudinal section is visible. The weld center A shown in FIG. 3A means a straight line along the up-down direction of the welded rail 1 that passes through a center of the heat-affected zone 12H in the longitudinal section of the welded joint part 12.

FIG. 3B is a micrograph taken in the longitudinal section of the welded rail 1 near the head top outer surface 1211. That is, FIG. 3B is a macrostructure photograph of a rectangular area indicated by a one-dot chain line near an upper end of the longitudinal section shown in FIG. 3A. In FIG. 3B, microstructural change in the heat-affected zone 12H in the longitudinal section of the head portion 121 of the welded joint part 12 are visible. The heat-affected zone 12H includes a region 12Hγ in which rail steel is austenitized as a result of the rail being reheated to an A1 point or higher during welding and is then subjected to pearlitic transformation, and a region 12HT in which the rail steel is partially austenitized as a result of the vicinity of the region being reheated to near the A1 point and is then subjected to the decomposition and spheroidization of a pearlite structure. In the present embodiment, a portion where the rail steel is austenitized by being reheated to the A1 point or higher during welding is defined as “re-y portion 12Hγ”, and a region where the rail steel is partially austenitized as a result of the vicinity thereof being reheated to near the A1 point and is then subjected to the decomposition and spheroidization of the pearlite structure is defined as “tempered portion 12HT”. The tempered portion 12 HT is a region where a so-called two-phase tempering phenomenon occurs. For reference, a line indicating a boundary between the tempered portion 12HT and the re-γ portion 12Hγ is added to the structure photograph of FIG. 3B.

A HAZ width is a width of the heat-affected zone (HAZ) 12H measured along the longitudinal direction of the welded rail 1. That is, the sum of lengths of the re-γ portion 12Hγ and the tempered portion 12HT in a rail longitudinal direction is called the HAZ width.

### (Definition of Terms Related to Heat Treatment Conditions)

In the step S1 of performing the first accelerated cooling on the welded joint part, an accelerated cooling start temperature means a temperature of the head top corner-side outer surface 1214 of the weld center A at the time when a cooling gas is started to be sprayed.

In the step S1 of performing the first accelerated cooling on the welded joint part, an average accelerated cooling rate in a temperature range of 750° C. to 600° C. of the head top corner-side outer surface is a value obtained by dividing 150° C. (=750° C.-600° C.) by a time required for the head top corner-side outer surface to decrease from 750° C. to 600° C. Similarly, in the step S1 of performing the first accelerated cooling on the welded joint part, an average accelerated cooling rate in a temperature range of 750° C. to 600° C. of the web outer surface is a value obtained by dividing 150° C. (=750° C.-600° C.) by a time required for the web outer surface to decrease from 750° C. to 600° C.

In the step S2 of stopping the first accelerated cooling of the welded joint part, an accelerated cooling stop temperature of the head top corner-side outer surface means the temperature of the head top corner-side outer surface 1214 of the weld center A at the time when the spraying of the cooling gas is stopped. In addition, similarly, an accelerated cooling stop temperature of the web outer surface 1221 means the temperature of the web outer surface 1221 of the weld center A at the time when the spraying of the cooling gas is stopped.

In the step S3 of heating the welded joint part, the average heating rate of the head top corner-side outer surface is a value obtained by dividing a difference between a heating start temperature of the head top corner-side outer surface and 620° C., which is a lower limit of a holding temperature range, by a time required to raise the temperature from the heating start temperature to 620° C. The heating start temperature of the head top corner-side outer surface means the temperature of the head top corner-side outer surface of the weld center A at the time when the heating of the welded joint part using a heating method is started. Similarly, the average heating rate of the web outer surface is a value obtained by dividing a difference between a heating start temperature of the web outer surface (the temperature of the web outer surface at the time when the heating is started) and 620° C. by a time required to raise the temperature from the heating start temperature to 620° C. The lower limit of the holding temperature range may be set to a value higher than 620° C. However, even in a case where the lower limit of the holding temperature range is set to a value other than 620° C., the definition of the average heating rate is not changed.

In the step S4 of holding the temperature of the welded joint part, a temperature holding time of the head top corner-side outer surface is a time during which the temperature of the head top corner-side outer surface 1214 of the weld center A is in a range of 620° C. to 670° C. That is, the temperature holding time is a length from a point in time at which the temperature of the head top corner-side outer surface 1214 of the weld center A is raised by heating and reaches 620° C. or higher to a point in time at which the temperature of the portion decreases and reaches lower than 620° C. Similarly, the temperature holding time of the web outer surface is a time during which the temperature of the web outer surface is in a range of 620° C. to 670° C. Even in a case where the holding temperature range is set to a range other than 620° C. to 670° C., the definition of the holding time is not changed.

In the step S5 of performing the second accelerated cooling on the heated welded joint part, a cooling stop temperature of the head top corner-side outer surface means the temperature of the head top corner-side outer surface 1214 of the weld center A at the time when the spraying of the cooling gas for the second accelerated cooling is stopped. In addition, a cooling start temperature of the head top corner-side outer surface means the temperature of the head top corner-side outer surface 1214 of the weld center A at the time when the spraying of the cooling gas for the second accelerated cooling is started. Similarly, a cooling stop temperature of the web outer surface is the temperature of the web outer surface of the weld center A at the time when the spraying of the cooling gas for the second accelerated cooling is stopped, and a cooling start temperature of the web outer surface is the temperature of the web outer surface of the weld center A at the time when the spraying of the cooling gas for the second accelerated cooling is started.

In the step S5 of performing the second accelerated cooling on the heated welded joint part, the average cooling rate of the head top corner-side outer surface is a value obtained by dividing a difference between the cooling start temperature and the cooling stop temperature of the head top corner-side outer surface by a cooling gas spray time. Similarly, the average cooling rate of the web outer surface is a value obtained by dividing a difference between the cooling start temperature and the cooling stop temperature of the web outer surface by the cooling gas spray time.

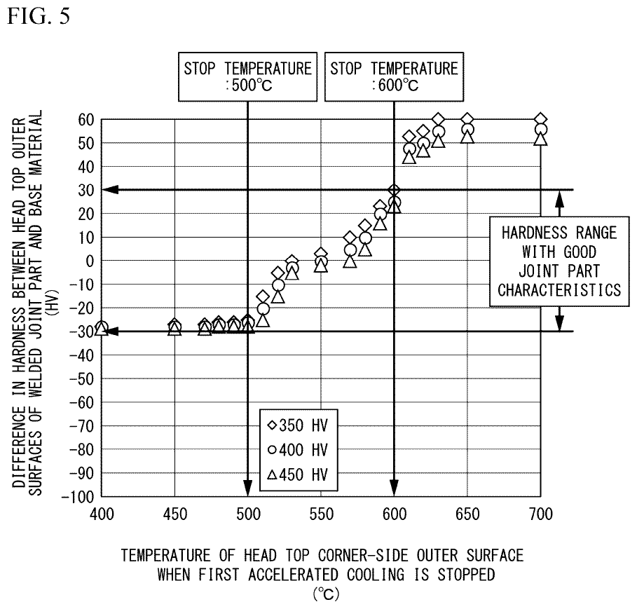

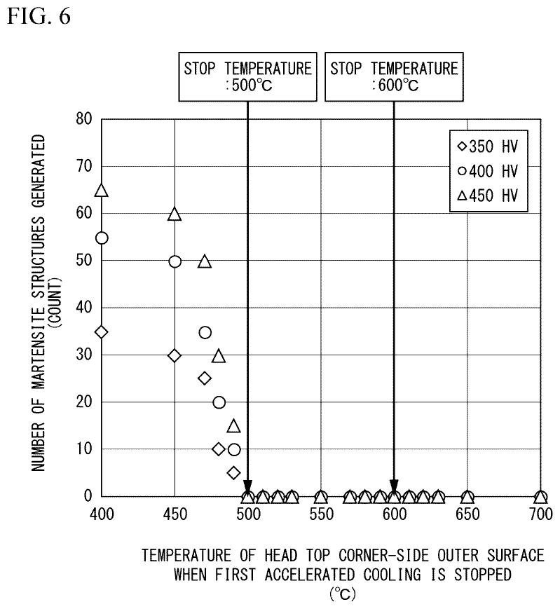

Next, experimental results that led to the technical idea of the heat treatment method according to the present embodiment will be described. First, experimental results will be described regarding a relationship between the average accelerated cooling rate of the head top corner-side outer surface and an absolute value of a difference in hardness between the head top outer surfaces of the welded joint part and the base material (see FIG. 4) in the step (S1) of performing the first accelerated cooling on the welded joint part 12, and a relationship between the temperature of the head top corner-side outer surface when the cooling is stopped and an absolute value of a difference in hardness between the welded joint part and the base material (see FIG. 5) and a relationship between the temperature of the head top corner-side outer surface when the cooling is stopped and the number of martensite structures generated (see FIG. 6) in the step (S2) of stopping the first accelerated cooling.

The present inventors have studied a method for controlling hardness of a welded joint part in flash butt welding of rails. As shown in FIG. 3B, the welded joint part includes the re-γ portion 12Hγ and the tempered portion 12HT. After the end of the flash butt welding, softening occurs in each of the re-γ portion 12Hγ and the tempered portion 12HT. However, a width of the re-γ portion 12Hγ is larger than a width of the tempered portion 12HT. Therefore, first, hardness of the re-γ portion 12Hγ was considered to be secured. The present inventors considered that, in order to control the hardness of the re-γ portion 12Hγ, it is important to perform the first accelerated cooling after the flash butt welding and to appropriately control the average cooling rate of the head top corner-side outer surface in the first accelerated cooling and the stop temperature of the first accelerated cooling. In addition, suitable cooling conditions were confirmed through experiments.

A flash butt welding test was conducted using a eutectoid steel rail and a hyper-eutectoid steel rail (both containing 0.75% to 1.20% C). After the welding, a welded joint part was subjected to first accelerated cooling. Various accelerated cooling rates and accelerated cooling stop temperatures were applied to the first accelerated cooling. Then, relationships between these conditions, and the hardness of the welded joint part and martensite structures were evaluated. A welded rail, flash butt welding conditions, cooling conditions for the welded joint part, characteristics of the welded joint part, the hardness of the welded joint part, an evaluation method for martensite structures, and evaluation of an effect of the hardness of the welded joint part on wear resistance of the welded joint part are as shown below.

### Welded Rails

Composition: 0.75% to 1.20% C, 0.40% Si, 0.80% Mn, 0.20% Cr, and a remainder including iron and impurities
Rail profile: 136 pounds (weight: 67 kg/m).
Hardness of a base material portion: 350 HV (0.75% C), 400 HV (0.90% C), 450 HV (1.10% C)

The hardness of the base material portion is a value measured by a method described later.

### Flash Butt Welding Conditions (Preheating Flash Method)

Initial flash time: 15 seconds
Number of times of preheating: 10 times
Later flash time: 20 seconds
Average later flash speed: 0.6 mm/sec
Later flash speed immediately before upsetting (for 3 seconds): 1.8 mm/sec
Amount of loss of later flash: 10 mm
Upset load: 65 kN
   Conditions for the First Accelerated Cooling Performed on the Welded Joint Part Immediately after Welding
Cooling method: Nozzles are disposed at equal intervals around the head portion of the welded joint part and air is sprayed
Control position: The head top corner-side outer surface 1214 and the web outer surface 1221 of the weld center A (see FIG. 2)
Temperature measurement method: Radiation-type thermometer (the same applies in other experiments)
Temperatures of the head top corner-side outer surface and the web outer surface when the first accelerated cooling is started: 700° C. or higher
Average accelerated cooling rate of the head top corner-side outer surface: 0.4 to 4.5° C./sec
Average accelerated cooling rate of the web outer surface: 0.4 to 5.0° C./sec
Accelerated cooling stop temperature: 400° C. to 700° C.
   In a case of an experiment (see FIG. 4) in which the average accelerated cooling rate of the head top corner-side outer surface was changed, the temperature of the head top corner-side outer surface when the first accelerated cooling was stopped was fixed at 570° C., and the temperature of the web outer surface when the first accelerated cooling was stopped was in a range of 550° C. to 570° C.
   In a case of an experiment (see FIGS. 5 and 6) in which the temperature of the head top corner-side outer surface was changed when the first accelerated cooling was stopped, the average accelerated cooling rate of the head top corner-side outer surface was fixed at 2.0° C./sec, and the average accelerated cooling rate of the web outer surface was in a range of 1.8 to 2.2° C./sec.

### Characteristics of the Welded Joint Part

HAZ width: 10 to 50 mm

### Heating Conditions for the Welded Joint Part

None.

### Evaluation Method for the Hardness of the Base Material Portion and the Welded Joint Part

Evaluation site of the hardness of the base material portion: Longitudinal section immediately below the rail head top outer surface 1111
Evaluation site of the hardness of the welded joint part 12: Longitudinal section immediately below the head top outer surface 1211 of the weld center A (see FIGS. 2 and 3A)
Evaluation of hardness: Longitudinal sections immediately below the rail head top outer surface 1111 and the head top outer surface 1211 were cut out, polished, and then evaluated using a Vickers hardness tester.
Polishing conditions: The longitudinal sections immediately below the rail head top outer surface 1111 and the head top outer surface 1211 were buff-polished with 1 μm diamond paste.
Hardness measuring instrument: Vickers hardness tester (load 10 kgf)

Under the above-described conditions, hardnesses at positions 5 mm deep from the head surface in the longitudinal sections of the base material portion and the welded joint part of the rail were measured at 80 points to the left and 80 points to the right from the weld center A along the longitudinal direction of the welded rail, for a total of 161 points. Measurement intervals were set to 1 mm. In addition, an average value of hardnesses at 20 points measured between 71 to 80 mm to the left and 71 to 80 mm to the right from the weld center A was regarded as the hardness of the base material portion, that is, the base material hardness. An average value of hardnesses at 10 points measured between 2 to 6 mm to the left and 2 to 6 mm to the right from the weld center A was regarded as the hardness of the welded joint part.

For reference, FIG. 3C shows a schematic diagram of a hardness distribution obtained by the above-described measurement method. Usually, hardness valleys appear on both sides of the weld center A. This valley of the hardness is referred to as a softest region. The “hardnesses at 20 points measured between 71 to 80 mm to the left and 71 to 80 mm to the right from the weld center A” described above are measurement points in a region that is not affected by welding heat and is located outside the softest region. The “hardnesses at 10 points measured between 2 to 6 mm to the left and 2 to 6 mm to the right from the weld center A” are regions located inside the softest region.

### Evaluation Method for Martensite Structures of a Flash-Butt-Welded Joint Part

Evaluation site B (see FIG. 3A): A region B of 0 to (⅔)×h from the head top outer surface 1211 and ±5 mm (total width 10 mm) in the longitudinal direction from the weld center A in the longitudinal section of the welded joint part 12.

Here, “h” means a height of the welded rail 1. Hereinafter, this site is referred to as a martensite evaluation region B.

Reason for selection of the evaluation site: The martensite evaluation region B is a site that is heated to an A1 point or higher in flash butt welding, and is a site that has been confirmed to be most likely to generate the martensite structure in previous flash butt welding tests.

Observation of the martensite structure: The martensite evaluation region B was polished, subjected to nital etching, and then observed with an optical microscope to check the presence or absence and the number of martensite structures.
Polishing conditions: Buff polishing with 1 μm diamond paste
Nital etching conditions: Alcohol+5% nitric acid
Optical microscope observation conditions: 200-fold
Visual field: Entire martensite evaluation region B

Evaluation of the martensite structure: A martensite structure that could be confirmed at 200-fold of the optical microscope was taken as an evaluation target. The presence or absence of the martensite structure and the number of martensite structures in a case where the martensite structure was generated were investigated.

A specific evaluation procedure of the martensite structure was as follows. An optical micrograph of the martensite evaluation region B at a magnification of 200-fold is taken. Then, the optical micrograph is binarized using an image analysis software. Since martensite is usually displayed in white, a white region occupying the martensite evaluation region B in the binarized optical micrograph can be regarded as a martensite structure. In this martensite structure, those having a major axis of 20 μm or more are taken as evaluation targets, and the number of martensite structures is calculated. In addition, in the welded joint part of the welded rail according to the present embodiment, microstructures other than the martensite structures are pearlite structures. In the optical micrograph of such microstructures, carbide-free martensite appears as white regions and can be clearly distinguished from pearlite.

There are cases where a small amount of a bainite structure is included in the welded joint part of the welded rail. However, in the welded rail according to the present embodiment, the bainite structure in the welded joint part is regarded as the martensite structure. This is because it is difficult to distinguish between the two in an optical micrograph, and furthermore, the two have substantially the same effect on the breakage resistance of the welded rail.

### Evaluation of the Hardness on the Wear Resistance of the Flash-Butt-Welded Joint Part

As the difference in hardness between the head top outer surfaces of the welded joint part and the rail base material decreases, unevenness due to wear of the welded joint part decreases, and a service life of the rail increases. In order to secure the wear resistance of the welded joint part, the difference in hardness between the head top outer surfaces of the welded joint part and the base material is desirably Δ30 HV or less. This difference in hardness is regulated by rail standards or the like (for example, A.R.E.M.A.: American Railway Engineering and Maintenance-of-Way Association).

As a result, as shown in FIG. 4, when the average accelerated cooling rate of the head top corner-side outer surface exceeded 3.5° C./sec, the hardness of the re-γ portion on the head top outer surface 1211 increased excessively, and the difference in hardness between the welded joint part and the base material (that is, a value obtained by subtracting the hardness of the base material from the hardness of the welded joint part) exceeded Δ30 HV. In the welded joint part in which the average accelerated cooling rate of the head top corner-side outer surface exceeded 3.5° C./sec, the unevenness due to wear increased, and the wear resistance of the welded joint part decreased.

In addition, when the average accelerated cooling rate of the head top corner-side outer surface of the welded joint part was slower than 1.0° C./sec, a pearlitic transformation temperature increased, and the hardness of pearlite generated by the transformation decreased. As a result, the hardness of the re-γ portion of the head top outer surface 1211 of the welded joint part decreased, and the difference in hardness between the welded joint part and the base material exceeded Δ30 HV. In addition, it was found that the unevenness due to wear of the welded joint part increased, and the wear resistance of the welded joint part decreased.

In addition, as shown in FIG. 5, when the temperature of the head top corner-side outer surface when the first accelerated cooling was stopped exceeded 600° C., the pearlitic transformation temperature increased, and the hardness of pearlite generated by the transformation decreased. As a result, the hardness of the re-γ portion of the head top outer surface 1211 of the welded joint part decreased, and the difference in hardness between the welded joint part and the base material exceeded Δ30 HV. In addition, the unevenness due to wear of the welded joint part increased, and the wear resistance of the welded joint part decreased.

In addition, as shown in FIG. 6, it was found that when the temperature of the head top corner-side outer surface when the first accelerated cooling is stopped is lower than 500° C., the number of generated coarse martensite structures that significantly reduce toughness in the inside of the head portion and the web portion of the welded joint part increases. As the number of the generated coarse martensite structures increases, the breakage resistance of the welded joint part decreases.

Therefore, it was found that in order to control the hardness of the welded joint part and to secure the wear resistance and the breakage resistance, it is necessary to control the average accelerated cooling rate of the head top corner-side outer surface and the accelerated cooling stop temperature of the head top corner-side outer surface within a certain range. In addition, the present inventors have newly found that in order to secure the breakage resistance of the welded joint part, it is necessary to suppress the generation of martensite structures, which are harmful to toughness, in the inside of the head portion and the web portion of the welded joint part.

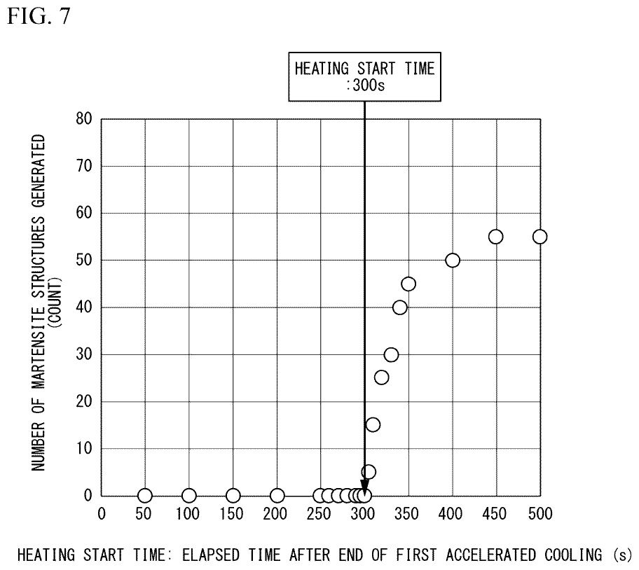

Next, experimental results regarding a relationship between a start time of heating in the step of heating the welded joint part 12 (S3) and the number of martensite structures generated will be described (see FIG. 7).

The present inventors have studied a method for further suppressing the generation of martensite structures generated in the inside of the head portion and the web portion of the welded joint part in flash butt welding of rails. First, the cause of the generation of the martensite structure was investigated in detail. As a result, the following became clear.

The inside of the head portion and the web portion of the welded joint part are locally heated during flash butt welding. Therefore, when the welded rail is naturally cooled after welding, cooling rates of the inside of the head portion and the web portion of the welded joint part are faster than a cooling rate of a rail after rail rolling during rail production. For this reason, martensite is more likely to be generated in the inside of the head portion and the web portion of the welded joint part than in the rail portion that is not affected by the welding heat. In addition, segregation of an alloy is present in the inside of the head portion and the web portion of the welded joint part. The present inventors have newly discovered that martensite structures are more likely to be generated in this segregation portion. Therefore, the cause of the segregation portion was investigated. As a result, it was found that segregation of the alloy inevitably occurs in a casting stage. Furthermore, the inventors have newly discovered that in the segregation portion, during the first accelerated cooling immediately after welding in which the cooling rate is faster than that in cooling after rolling, the pearlitic transformation is not ended, an austenite structures remain, and as a result, martensite structures are generated. For the above reasons, the amount of martensite generated differs between the welded joint part, which is affected by the welding heat, and the rail portion, which is a base material and is not affected by the welding heat.

For the above reasons, when the first accelerated cooling is performed on the welded joint part after flash butt welding, martensite, which is a cause of breakage, is generated in the welded joint part.

However, as described with reference to FIG. 4 and the like, in order to secure the wear resistance by increasing the hardness of the welded joint part, accelerated cooling is essential. Therefore, the present inventors have studied a heat treatment method in which the pearlitic transformation is ended after the first accelerated cooling, which is started immediately after welding, is stopped. As a result, the present inventors found a method of completing pearlitic transformation and preventing the generation of martensite structures by heating the welded joint part within a certain period of time after the first accelerated cooling and holding the welded joint part in a pearlitic transformation temperature range.

This heat treatment method was examined in detail. First, an effect of a heating start time of the welded joint part was investigated. A flash butt welding test was conducted using a eutectoid steel rail and a hyper-eutectoid steel rail (both containing 0.75% to 1.20% C). First accelerated cooling was performed after welding, and a relationship between a time from the stop of the first accelerated cooling to the start of heating and the amount of martensite structures generated was evaluated. A welded rail, first accelerated cooling conditions for the welded joint part immediately after welding, heating conditions for the welded joint part after the first accelerated cooling, and the characteristics of the flash-butt-welded joint part are as shown below. In addition, other experimental conditions and the like were the same as the conditions for the welding test described above.

### Welded Rails

Composition: 0.90% C, 0.40% Si, 0.80% Mn, 0.20% Cr, and a remainder including iron and impurities
Rail profile: 136 pounds (weight: 67 kg/m).
Hardness of a base material portion: 400 HV (the rail head top outer surface 1111, see FIG. 2)
   First Accelerated Cooling Conditions for the Welded Joint Part Immediately after Welding
Control position: The head top corner-side outer surface 1214 of the weld center A and the web outer surface 1221 (see FIG. 2)
Average accelerated cooling rate of the head top corner-side outer surface: 2.0° C./sec
Average accelerated cooling rate of the web outer surface: 2.3° C./sec
Temperature of the head top corner-side outer surface when the first accelerated cooling is stopped: 570° C.
Temperature of the web outer surface when the first accelerated cooling is stopped: 560° C.

### Heating Conditions for the Welded Joint Part

Control position: The head top corner-side outer surface 1214 of the weld center A and the web outer surface 1221 (see FIG. 2)
Heating start time: 50 to 500 seconds after the cooling of the welded joint part is stopped
Average heating rates of the head top corner-side outer surface and the web outer surface: 0.5 to 2.0° C./sec
Holding temperature ranges of the head top corner-side outer surface and the web outer surface: 620° C. to 670° C.
Holding time of the head top corner-side outer surface and the web outer surface: 30 to 180 seconds
Cooling after holding: The head top corner-side outer surface and the web outer surface are naturally cooled to 200° C. (the average cooling rates of the head top corner-side outer surface and the web outer surface are 0.1 to 0.4° C./sec)
Heating method: Energization heating or high-frequency heating

### Characteristics of the Flash-Butt-Welded Joint Part

Evaluation site: Head top outer surface 1211 of the weld center A (see FIG. 2)
HAZ width: 10 to 50 mm
Hardness (re-γ portion): 380 to 420 HV

As a result, as shown in FIG. 7, it was found that when the time from the stop of the first accelerated cooling to the start of heating exceeded 300 seconds, the number of martensite structures in the welded joint part increased. The reason for this is presumed to be that, before the start of heating, the temperatures of the inside of the head portion and the inside of the web portion of the welded joint part decrease and martensitic transformation occurs. Even after the stop of the first accelerated cooling, that is, the stop of the spraying of a cooling medium for the first accelerated cooling, there is a temperature difference between the rail and the atmosphere. Therefore, even after the first accelerated cooling is stopped, the temperature of the welded joint part continues to decrease. Therefore, the temperatures of the inside of the head portion and the inside of the web portion of the welded joint part decrease. Furthermore, in the subsequent heating, the martensite structures do not disappear. In a case where heating is performed at a higher temperature than the above-described conditions in order to eliminate the martensite structures, the effect of the first accelerated cooling performed to secure the hardness of the welded joint part is lost. Therefore, it was found that in order to prevent the generation of the martensite structures in the welded joint part, it is necessary to control the time from the stop of the first accelerated cooling to the start of heating within a predetermined range.

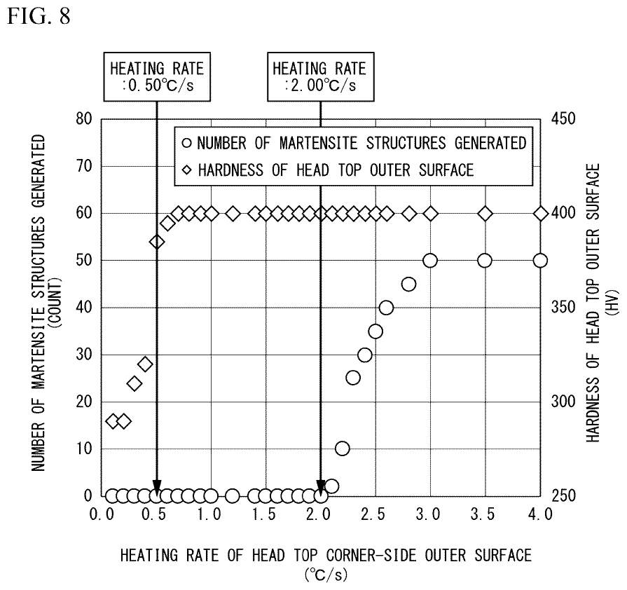

Furthermore, results of an experiment evaluating a relationship between the average heating rate of the head top corner-side outer surface of the welded joint part and the amount of martensite structures generated in the inside of the head portion and the inside of the web portion of the welded joint part (see FIG. 8) and a relationship between the average heating rate of the head top corner-side outer surface and the hardness of the head top outer surface (see FIG. 8) in the step of heating the welded joint part 12 (S3) will be described. A welded rail, cooling conditions for the welded joint part, heating conditions for the welded joint part, and characteristics of the flash-butt-welded joint part are as shown below. In addition, other test conditions and the like were the same as the conditions for the welding test described above.

### Welded Rails

The same welded rail as that used to obtain the experimental results shown in FIG. 7 was used.

### First Accelerated Cooling Conditions for the Welded Joint Part

Control position: The head top corner-side outer surface 1214 of the weld center A and the web outer surface 1221 (see FIG. 2)
Average accelerated cooling rate of the head top corner-side outer surface: 2.0° C./sec
Average accelerated cooling rate of the web outer surface: 2.3° C./sec
Temperature of the head top corner-side outer surface when the first accelerated cooling is stopped: 570° C.
Temperature of the web outer surface when the first accelerated cooling is stopped: 560° C.

### Heating Conditions for the Welded Joint Part

Control position: The head top corner-side outer surface 1214 of the weld center A and the web outer surface 1221 (see FIG. 2)
Heating start time: Within 200 seconds after the first accelerated cooling of the welded joint part is stopped
Average heating rates of the head top corner-side outer surface and the web outer surface: 0.1 to 4.0° C./sec
Holding temperature ranges of the head top corner-side outer surface and the web outer surface: 620° C. to 670° C.
Temperature holding times of the head top corner-side outer surface and the web outer surface: 30 to 180 seconds
Cooling after holding: The head top corner-side outer surface and the web outer surface are naturally cooled to 200° C. (the average cooling rates of the head top corner-side outer surface and the web outer surface are 0.1 to 0.4° C./sec).
Heating method: Energization heating or high-frequency heating

### Characteristics of the Flash-Butt-Welded Joint Part

Evaluation site: Head top outer surface 1211 of the weld center A (see FIG. 2)
HAZ width: 10 to 50 mm

As a result, as shown in FIG. 8, when the average heating rate of the head top corner-side outer surface exceeded 2.0° C./sec, the generation of martensite structures was observed in the martensite evaluation region B in the inside of the head portion and the inside of the web portion. This is presumed to be because the temperature difference between the head side outer surface of the welded joint part and the inside of the head portion and the inside of the web portion of the welded joint part increases, the temperature of the inside of the head portion of the welded joint part does not sufficiently rise, and pearlitic transformation is not promoted. In particular, in a case where the rail was heated by high-frequency heating, the effect of the above-described phenomenon was significant.

In addition, it was found that when the average heating rate of the head top corner-side outer surface is slower than 0.5° C./sec, the hardness of the head top outer surface decreases. This is presumed to be because the welded joint part is tempered. Therefore, it was found that in order to prevent the generation of the martensite structures in the welded joint part and to suppress the decrease in hardness, it is necessary to control the average heating rate of the head top corner-side outer surface within a certain range. The average heating rate was substantially the same on the head top corner-side outer surface and the web outer surface.

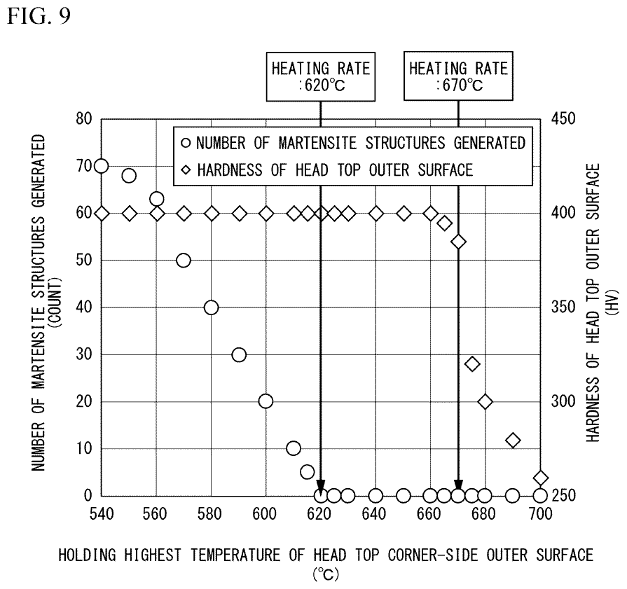

Next, a relationship between a heating holding temperature of the welded joint part and the amount of martensite structures generated in the inside of the head portion and the inside of the web portion of the welded joint part (see FIG. 9) and a relationship between the heating holding temperature and the hardness of the head top outer surface (see FIG. 9) in the step of holding the temperature of the welded joint part 12 (S4) were evaluated. A welded rail, cooling conditions for the welded joint part, and heating conditions for the welded joint part are as shown below. Other test conditions and the like were the same as the conditions for the welding test described above.

### Welded Rails

The same welded rail as that used to obtain the experimental results shown in FIG. 7 was used.

### First Accelerated Cooling Conditions for the Welded Joint Part

Control position: The head top corner-side outer surface 1214 of the weld center A and the web outer surface 1221 (see FIG. 2)
Average accelerated cooling rate of the head top corner-side outer surface: 2.0° C./sec
Average accelerated cooling rate of the web outer surface: 2.3° C./sec
Temperature of the head top corner-side outer surface when the first accelerated cooling is stopped: 570° C.
Temperature of the web outer surface when the first accelerated cooling is stopped: 560° C.

### Heating Conditions for the Welded Joint Part

Control position: The head top corner-side outer surface 1214 of the weld center A and the web outer surface 1221 (see FIG. 2)
Heating start time: Within 200 seconds after the cooling of the welded joint part immediately after welding is stopped
Average heating rates of the head top corner-side outer surface and the web outer surface: 0.5 to 2.0° C./sec
Holding temperature ranges of the head top corner-side outer surface and the web outer surface: 500° C. to 700° C.
Holding Times of the head top corner-side outer surface and the web outer surface: 0 to 210 seconds
Cooling after holding: The head top corner-side outer surface and the web outer surface are naturally cooled to 200° C. (the average cooling rates of the head top corner-side outer surface and the web outer surface are 0.1 to 0.4° C./sec).
   As described above, the term “holding time of the head top corner-side outer surface” refers to a time during which the temperature of the head top corner-side outer surface 1214 of the weld center A was in a range of 620° C. to 670° C. However, in this experiment, there were cases where the temperature was held in a temperature range of higher than 670° C. The holding time in this case means an isothermal holding time at the maximum temperature.

As a result, as shown in FIG. 9, it was found that when a holding highest temperature of the head top corner-side outer surface exceeds 650° C., the welded joint part is tempered and the hardness of the head top outer surface decreases. In addition, when the holding highest temperature of the head top corner-side outer surface was lower than 580° C., a pearlitic transformation rate significantly decreased, the pearlitic transformation was not completed, and the generation of martensite structures was observed in the martensite evaluation region B in the inside of the head portion and the inside of the web portion. Therefore, it was found that in order to prevent the generation of martensite structures in the welded joint part and to suppress the decrease in hardness, it is necessary to control the holding temperature of the head top corner-side outer surface within a certain range.

The holding highest temperature was substantially the same on the head top corner-side outer surface and the web outer surface.

Furthermore, a relationship between a heating holding time and the amount of martensite structures generated (FIG. 10) and a relationship between the heating holding time and the hardness of the head top outer surface (FIG. 10) in the step (S4) of holding the temperature of the welded joint part 12 were evaluated. A welded rail, cooling conditions for the welded joint part, and heating conditions for the welded joint part are as shown below. Other test conditions and the like were the same as the conditions for the welding test described above.

### Welded Rails

The same welded rail as that used to obtain the experimental results shown in FIG. 7 was used.

### First Accelerated Cooling Conditions for the Welded Joint Part

Control position: The head top corner-side outer surface 1214 of the weld center A and the web outer surface 1221 (see FIG. 2)
Average accelerated cooling rate of the head top corner-side outer surface: 2.0° C./sec
Average accelerated cooling rate of the web outer surface: 2.3° C./sec
Temperature of the head top corner-side outer surface when the first accelerated cooling is stopped: 570° C.
Temperature of the web outer surface when the first accelerated cooling is stopped: 560° C.

### Heating Conditions for the Welded Joint Part

Control position: The head top corner-side outer surface 1214 of the weld center A and the web outer surface 1221 (see FIG. 2)
Heating start times of head top corner-side outer surface and web outer surface: Within 200 seconds after the stop of the cooling of the welded joint part Average heating rates of the head top corner-side outer surface and the web outer surface: 0.5 to 2.0° C./sec
Holding temperature ranges of the head top corner-side outer surface and the web outer surface: 620° C. to 670° C.
Temperature holding times of the head top corner-side outer surface and the web outer surface: 5 to 210 seconds
Cooling after holding: The head top corner-side outer surface and the web outer surface are naturally cooled to 200° C. or lower (the average cooling rates of the head top corner-side outer surface and the web outer surface are 0.1 to 0.4° C./sec).

As a result, as shown in FIG. 10, it was found that when a holding time for holding the temperature of the head top corner-side outer surface of the welded joint part exceeds 180 seconds, the welded joint part is tempered and the hardness of the head top outer surface of the welded Joint part decreases. In addition, when the holding time of the temperature of the head top corner-side outer surface of the welded joint part was shorter than 30 seconds, the pearlitic transformation was not ended within the holding time, and the generation of martensite structures was observed in the martensite evaluation region B in the inside of the head portion and the inside of the web portion. Therefore, it was found that in order to prevent the generation of martensite structures in the welded joint part and to suppress the decrease in hardness, it is necessary to control the holding time of the temperature of the head top corner-side outer surface of the welded joint part within a certain range.

The temperature holding time was substantially the same on the head top corner-side outer surface and the web outer surface.

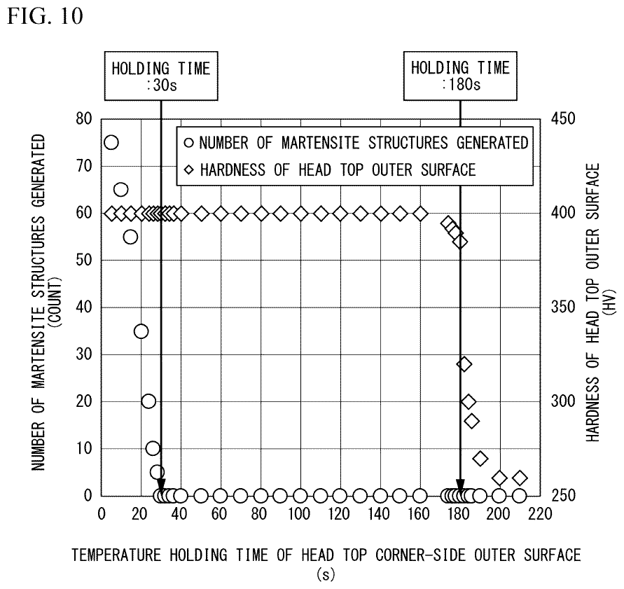

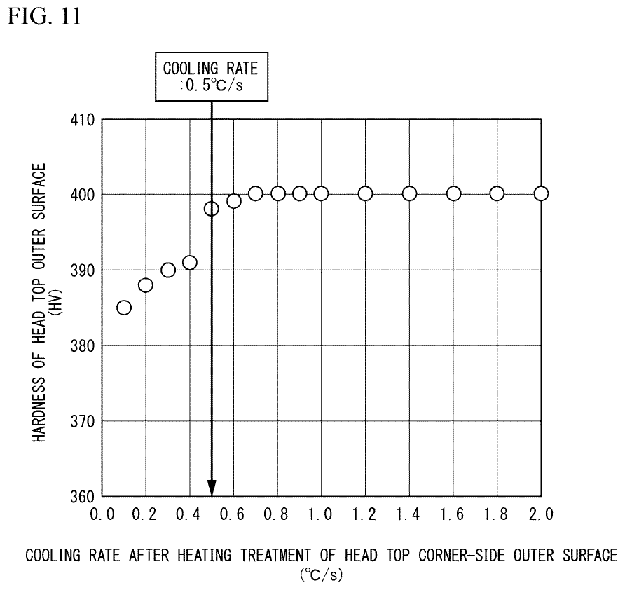

Next, experimental results regarding a relationship between the cooling rate and the hardness of the head top outer surface (see FIG. 11) and a relationship between the cooling stop temperature and the hardness of the head top outer surface (see FIG. 12) in the step (S5) of performing the second accelerated cooling on the welded joint part will be described.

After the holding S4, the welded joint part may be naturally cooled. Accordingly, the wear resistance and the breakage resistance of the welded joint part can be sufficiently improved. However, in order to further suppress the decrease in hardness of the head top outer surface of the welded joint part, it was also considered preferable to perform the accelerated cooling again after the holding S4. Therefore, a relationship between cooling conditions after the heating and the temperature holding and the hardness of the head top outer surface were evaluated. Hereinafter, the accelerated cooling performed after the holding S4 will be referred to as the second accelerated cooling S5.

Heating conditions for the welded joint part, temperature holding conditions, and the cooling conditions in the second accelerated cooling S5 are as shown below. A welded rail, the cooling conditions for the welded joint part, and the heating conditions for the welded joint part were set to conditions under which tempering was likely to occur. Other test conditions were the same as the conditions for the welding test described above.

### Welded Rails

The same welded rail as that used to obtain the experimental results shown in FIG. 7 was used.

### First Accelerated Cooling Conditions for the Welded Joint Part

Control position: The head top corner-side outer surface 1214 of the weld center A and the web outer surface 1221 (see FIG. 2)
Average accelerated cooling rate of the head top corner-side outer surface: 2.0° C./sec
Average accelerated cooling rate of the web outer surface: 2.3° C./sec
Temperature of the head top corner-side outer surface when the first accelerated cooling is stopped: 570° C.
Temperature of the web outer surface when the first accelerated cooling is stopped: 560° C.

### Heating Conditions for the Welded Joint Part

Control position: The head top corner-side outer surface 1214 of the weld center A and the web outer surface 1221 (see FIG. 2)
Heating start time: Within 200 seconds after the cooling of the welded joint part immediately after welding is stopped
Average heating rates of the head top corner-side outer surface and the web outer surface: 0.6° C./sec
Holding temperature ranges of the head top corner-side outer surface and the web outer surface: 630° C.
Temperature holding times of the head top corner-side outer surface and the web outer surface: 80 seconds

### Cooling Conditions in the Second Accelerated Cooling

Average cooling rates of the head top corner-side outer surface and the web outer surface: 0.1 to 2.0° C./sec
Cooling start temperature: When the temperatures of the head side outer surface and the web outer surface of the weld center A are in a range of 600° C. or higher
Cooling stop temperatures of the head top corner-side outer surface and the web outer surface: 100° C. to 340° C.
Cooling method: Nozzles are disposed at equal intervals around the head portion of the welded joint part and air is sprayed
   In a case of an experiment in which the cooling rate is changed, the cooling stop temperatures of the head top corner-side outer surface and the web outer surface are fixed at 140° C.
   In a case of an experiment in which the cooling stop temperature is changed, the average cooling rates of the head top corner-side outer surface and the web outer surface are fixed at 0.7° C./sec.

As a result, as shown in FIG. 11, it was found that the hardness of the head top outer surface of the welded joint part is further improved by setting the average cooling rate of the head top corner-side outer surface to 0.5° C./sec or faster in the second accelerated cooling. In addition, as shown in FIG. 12, it was found that when the temperature of the head top corner-side outer surface during the cooling stop of the second accelerated cooling is set to 200° C. or lower, the hardness of the head top outer surface of the welded joint part is further improved. Therefore, it was also found that in order to further improve the hardness of the welded joint part, it is preferable to control the average cooling rate and the cooling stop temperature of the second accelerated cooling within certain ranges.

The average cooling rate and the cooling stop temperature were substantially the same on the head top corner-side outer surface and the web outer surface.

The experimental results that led to the finding of the heat treatment method according to the present embodiment have been described above. Next, the heat treatment method according to the present embodiment will be described in detail.

### (S1) Reasons for Limiting Conditions for Step of Performing First Accelerated Cooling on Welded Joint Part 12

The reasons for limiting the first accelerated cooling conditions will be described. Measurement sites of the temperatures are the head top corner-side outer surface 1214 and the web outer surface 1221 of the weld center A shown in FIG. 2A. The first accelerated cooling may be performed on the welded joint part so that the temperatures at the measurement sites satisfy the following requirements. A preferable example of a specific method for the first accelerated cooling will be described below.

### (a) Conditions for Starting First Accelerated Cooling of Welded Joint Part

Conditions for starting the first accelerated cooling S1 of the welded joint part will be described. The first accelerated cooling is started when the temperature s of the head top corner-side outer surface and the web outer surface in the weld center of the welded joint part are in a range of 700° C. or higher.

For example, the conditions can be achieved by starting the use of a cooling method for performing the first accelerated cooling S1 within 60 seconds from the time when the flash butt welding is ended. Here, the time when the flash butt welding is ended refers to the time when an upsetting step is ended and pressing of the rail is ended. After the end of the upsetting, an operation called trimming is usually performed to remove excess portions of the welded Joint part. This operation is performed within the above time (for example, 60 seconds).

Usually, at the time when the flash butt welding is ended, the temperature of the welded joint part has a value close to a melting point of steel. After the welding is ended, the temperature of the welded joint part decreases due to a temperature difference between the welded joint part and the air and heat transfer from the welded joint part to the base material portion. Due to this temperature decrease, it is desirable to start using the cooling method for performing the first accelerated cooling S1 before the temperatures of the head top corner-side outer surface and the web outer surface of the weld center A fall below 700° C.

When the first accelerated cooling S1 is started before the temperatures of the head top corner-side outer surface and the web outer surface of the weld center A fall below 700° C., the hardness of the head top outer surface of the welded joint part can be further increased. More preferably, the first accelerated cooling S1 is started within 55 seconds, 50 seconds, or 45 seconds after the end of the flash butt welding. Furthermore, more preferably, the first accelerated cooling S1 is started when the temperature of the head top corner-side outer surface of the weld center A is 720° C. or higher, 750° C. or higher, or 800° C. or higher.

### (b) Average Accelerated Cooling Rate of Head Top Corner-Side Outer Surface 1214

When the average accelerated cooling rate of the head top corner-side outer surface 1214 in the first accelerated cooling S1 exceeds 3.5° C./sec, the hardness of the re-γ portion of the welded joint part increases. As a result, the difference in hardness between the welded joint part and the base material exceeds Δ30 HV. In this case, as the number of years of use of the welded rail increases, unevenness due to wear of the welded joint part increases. That is, the wear resistance of the welded joint part decreases.

In addition, when the average accelerated cooling rate of the head top corner-side outer surface 1214 is lower than 1.0° C./sec, the pearlitic transformation temperature increases, and the hardness of pearlite generated by the transformation decreases. As a result, the hardness of the re-γ portion of the welded joint part decreases, and the difference in hardness between the welded joint part and the base material exceeds Δ30 HV. In this case, as the number of years of use of the welded rail increases, the unevenness due to wear of the welded joint part increases. That is, the wear resistance of the welded joint part decreases.

Therefore, the average accelerated cooling rate of the head top corner-side outer surface 1214 in the first accelerated cooling S1 was limited to a range of 1.0 to 3.5° C./sec. In addition, a lower limit of the average accelerated cooling rate of the head top corner-side outer surface 1214 is preferably 1.1° C./sec or faster or 1.2° C./sec or faster. In addition, an upper limit of the average accelerated cooling rate of the head top corner-side outer surface 1214 is preferably 2.9° C./sec or slower, or 2.8° C./sec or slower. In order to stably secure the hardness of the re-γ portion of the welded joint part and to improve the wear resistance of the welded joint part, it is desirable to set the average accelerated cooling rate to 1.1 to 2.9° C./sec.

### (c) Average Accelerated Cooling Rate of Web Outer Surface 1221

When the average accelerated cooling rate of the web outer surface 1221 in the first accelerated cooling S1 exceeds 4.0° C./sec, the hardness of the re-γ portion of the welded joint part increases. As a result, the toughness of the web portion decreases, and the breakage resistance of the welded joint part decreases.

In addition, when the average accelerated cooling rate of the web outer surface 1221 in the first accelerated cooling S1 is slower than 1.0° C./sec, the pearlitic transformation temperature increases, and the hardness of pearlite generated by the transformation decreases. As a result, the strength of the web portion decreases, and fatigue damage resistance of the welded joint part decreases.

Therefore, the average accelerated cooling rate of the web outer surface 1221 in the first accelerated cooling S1 was limited to a range of 1.0 to 4.0° C./sec. In addition, a lower limit of the average accelerated cooling rate of the web outer surface 1221 is preferably 1.1° C./sec or faster or 1.2° C./sec or faster. In addition, an upper limit of the average accelerated cooling rate of the web outer surface 1221 is preferably 2.9° C./sec or slower, or 2.8° C./sec or slower. In order to stably secure the hardness of the re-γ portion of the welded joint part and to improve the breakage resistance and the fatigue damage resistance of the welded joint part, it is desirable to set the average accelerated cooling rate to 1.1 to 2.9° C./sec.

As described above, the web outer surface 1221 is a surface of a portion which is a middle portion between a center of the web portion 122 and a lower end of the head portion 121 and is close to the fillet portion 1212. The cooling rate of the web portion is controlled in a region slightly closer to the head portion than the center of the web portion.

### (S2) Reasons for Limiting Conditions for Step of Stopping First Accelerated Cooling

### (d) Stop Temperature of First Accelerated Cooling

When the stop temperature of the first accelerated cooling of the head top corner-side outer surface and the web outer surface exceeds 600° C., the pearlitic transformation temperature increases, and the hardness of pearlite generated by the transformation decreases. As a result, the hardness of the re-γ portion of the welded joint part decreases, and the difference in hardness between the welded joint part and the base material at the head top portion exceeds Δ30 HV. In this case, as the number of years of use of the welded rail increases, the unevenness due to wear of the welded joint part increases. That is, the wear resistance of the welded joint part decreases. In addition, in the web portion, the strength decreases and the fatigue damage resistance of the welded joint part decreases.

In addition, when the stop temperature of the first accelerated cooling of the head top corner-side outer surface and the web outer surface is lower than 500° C., in the head top portion, there is a concern that bainite structures, which are harmful to wear resistance, are generated on the head top outer surface of the welded joint part. Furthermore, even in the inside of the head portion inside and the web portion of the welded joint part, martensite structure, which are harmful to toughness, may be generated immediately after the stop of the accelerated cooling depending on the selection of the accelerated cooling temperature. Even when the subsequent heating S3 is performed, the martensite structures remain in the welded joint part.

Therefore, the stop temperature of the first accelerated cooling of the head top corner-side outer surface and the web outer surface was limited to a range of 500° C. to 600° C. In addition, a lower limit of the stop temperature of the first accelerated cooling of the head top corner-side outer surface and the web outer surface is preferably 510° C. or higher or 520° C. or higher. In addition, an upper limit of the stop temperature of the first accelerated cooling of the head top corner-side outer surface and the web outer surface is preferably 590° C. or lower or 580° C. or lower. In the welded joint part, in order to stably secure the hardness of the re-γ portion of the head top portion, to suppress the generation of the bainite structures on the head top outer surface, to secure the strength of the web portion, to prevent the generation of the martensite structures in the inside of the head portion and the inside of the web portion, and to improve the wear resistance, fatigue damage resistance, and breakage resistance of the welded joint part, it is desirable to set the stop temperature of the first accelerated cooling of the head top corner-side outer surface and the web outer surface to 510° C. to 590° C.

### (S3) Reasons for Limiting Conditions for Step of Heating Welded Joint Part 12

The reasons for limiting the heating conditions in the heating S3 will be described. Temperature control sites are the head top corner-side outer surface 1214 and the web outer surface 1221 of the weld center A shown in FIG. 2. The heating may be performed on the welded joint part so that the temperatures at the measurement sites satisfy the following requirements.

### (e) Heating Start Time

When the start time of the heating S3 exceeds 300 seconds after the stop of the first accelerated cooling S1, the temperatures of the inside of the head portion and the inside of the web portion of the welded joint part decrease before the start of the heating S3. Accordingly, martensitic transformation occurs in the inside of the head portion and the inside of the web portion of the welded joint part. In the subsequent heating S3, the martensite structures do not disappear.

Therefore, in order to prevent the generation of the martensite structures in the welded joint part, the start time of the heating S3 was limited to a range within 300 seconds after the stop of the first accelerated cooling S1. In addition, the start time of the heating S3 is preferably within 200 seconds or 100 seconds after the stop of the first accelerated cooling S1.

### (f) Average Heating Rate

When the average heating rates of the head top corner-side outer surface and the web outer surface exceed 2.0° C./sec, the temperature differences between the head side outer surface of the welded joint part and the inside of the head portion and between the web outer surface and the inside of the web portion increase, and the temperatures of the head portion and the inside of the web portion of the welded joint part do not sufficiently rise. Accordingly, the pearlitic transformation of the inside of the head portion and the inside of the web portion of the welded joint part is not promoted, and martensite structures are generated. In a case where the welded Joint part is heated by high-frequency heating, this phenomenon is particularly noticeable. In addition, when the average heating rate is slower than 0.5° C./sec, tempering occurs in the welded joint part, and the hardnesses of the head top portion and the web portion decrease.

Therefore, in order to prevent the generation of the martensite structures in the inside of the head portion and the inside of the web portion of the welded joint part and to suppress the decrease in hardness of the head top outer surface, the average heating rates of the head top corner-side outer surface and the web outer surface were limited to a range of 0.5 to 2.0° C./sec. In addition, a lower limit of the average heating rates of the head top corner-side outer surface and the web outer surface is preferably 0.6° C./sec or faster or 0.7° C./sec or faster. In addition, an upper limit of the average heating rates of the head top corner-side outer surface and the web outer surface is preferably 1.9° C./sec or slower or 1.8° C./sec or slower. In order to stably secure the hardnesses of the head top portion and the web portion of the welded joint part, to prevent the generation of martensite structures in the inside of the head portion and the inside of the web portion, and to improve the wear resistance, fatigue damage resistance, and breakage resistance of the welded joint part, it is desirable to set the average heating rates of the head top corner-side outer surface and the web outer surface to 0.7 to 1.8° C./sec.

### (S4) Reasons for Limiting Conditions for Step of Holding Temperature of Welded Joint Part 12

### (h) Holding Temperature Range

When the temperatures of the head top corner-side outer surface and the web outer surface of the welded joint part are within the holding temperature range, the heat input from the heating method to the welded joint part is reduced. Accordingly, the temperatures of the head top corner-side outer surface and the web outer surface of the welded joint part are maintained in the holding temperature range.

When the holding temperatures of the head top corner-side outer surface and the web outer surface exceed 670° C., a tempered portion is generated in the welded joint part, and the hardness of the head top portion and the web portion of the welded joint part decreases. In addition, when the holding temperatures of the head top corner-side outer surface and the web outer surface are lower than 620° C., the pearlitic transformation rate significantly decreases, the pearlitic transformation in the inside of the head portion and the inside of the web portion of the welded joint part is not completed, and martensite structures are generated.

Therefore, in order to suppress the decrease in hardness of the head top portion and the web portion of the welded joint part and to prevent the generation of martensite structures, the holding temperatures of the head top corner-side outer surface and the web outer surface were limited to a range of 620° C. to 670° C. In a case where the temperature of the head top corner-side outer surface is held in a range of 620° C. to 670° C., the holding temperature of the web outer surface is also often in a range of 620° C. to 670° C. or a value close thereto. In addition, a lower limit of the holding temperature ranges of the head top corner-side outer surface and the web outer surface is preferably 625° C. or higher or 630° C. or higher. In addition, an upper limit of the holding temperature ranges of the head top corner-side outer surface and the web outer surface is preferably 660° C. or lower or 650° C. or lower. In order to stably secure the hardnesses of the head top portion and the web portion of the welded joint part, to prevent the generation of the martensite structures in the inside of the head portion and the web portion, and to improve the wear resistance and the breakage resistance of the welded joint part, it is desirable to set the holding temperature ranges of the head top corner-side outer surface and the web outer surface to 625° C. to 660° C.

The holding temperature does not need to be constant. In a holding temperature range of 620° C. to 670° C., the temperatures of the head top corner-side outer surface and the web outer surface of the welded joint part may fluctuate. On the other hand, in a case where the holding highest temperature of the head top corner-side outer surface and the web outer surface, that is, the highest temperature during reheating, does not reach 620° C. or exceeds 670° C., the above-described temperature holding effect cannot be obtained.

### (i) Holding Time

When the temperature holding times of the head top corner-side outer surface and the web outer surface exceed 180 seconds, a tempered portion is generated in the welded joint part, and the hardnesses of the head top portion and the web portion decrease. In addition, when the temperature holding times of the head top corner-side outer surface and the web outer surface are shorter than 30 seconds, the pearlitic transformation rate significantly decreases, the pearlitic transformation in the inside of the head portion and the inside of the web portion is not completed, and martensite structures are generated.

Therefore, in order to prevent the generation of the martensite structures in the inside of the head portion and the inside of the web portion of the welded joint part and to suppress the decrease in hardness of the head top portion and the web portion, the temperature holding times of the head top corner-side outer surface and the web outer surface were limited to a range of 30 to 180 seconds. In addition, a lower limit of the temperature holding times of the head top corner-side outer surface and the web outer surface is preferably 34 seconds or longer or 40 seconds or longer. In addition, an upper limit of the temperature holding times of the head top corner-side outer surface and the web outer surface is preferably 116 seconds or shorter or 110 seconds or shorter. In order to stably secure the hardnesses of the head top portion and the web portion of the welded joint part, to prevent the generation of the martensite structures in the inside of the head portion and the web portion, and to improve the wear resistance and the breakage resistance of the welded joint part, it is desirable to set the temperature holding times of the head top corner-side outer surface and the web outer surface to 40 to 110 seconds.

(S5) Reasons for Limiting Conditions for Second Accelerated Cooling of welded Joint Part that May be Performed after Holding S4

Cooling conditions for the welded joint part after the end of the holding S4 are not particularly limited. For example, after the end of the holding S4, the welded joint part may be left in the air to be slowly cooled (so-called natural cooling). Meanwhile, similar to the first accelerated cooling S1 performed immediately after the flash butt welding, the welded joint part may be subjected to accelerated cooling again after the holding S4. Hereinafter, the accelerated cooling performed after the holding S4 will be referred to as the second accelerated cooling S5.

### (j) Average Cooling Rate

In the second accelerated cooling S5, when the average cooling rates of the head top corner-side outer surface and the outer surface of the web portion are set to 0.5° C./sec or faster, the tempering of the welded joint part is suppressed, and the hardnesses of the head top portion and the web portion of the welded joint part are further increased. Therefore, in order to further increase the hardness of the welded joint part, it is preferable to control the average cooling rates of the head top corner-side outer surface and the outer surface of the web portion in the second accelerated cooling S5 to 0.5° C./sec or faster. In addition, an upper limit of the average cooling rates of the head top corner-side outer surface and the outer surface of the web portion is preferably 0.6° C./sec or faster or 0.7° C./sec or faster. In this case, it is preferable that the second accelerated cooling S5 is started as quickly as possible. For example, it is preferable to start the second accelerated cooling S5 when the temperatures of the head side outer surface and the outer surface of the web portion of the weld center A are in a range of 600° C. or higher.

### (k) Cooling Stop Temperature

In addition, when the cooling stop temperatures of the head top corner-side outer surface and the outer surface of the web portion are set to 200° C. or lower, the tempering of the welded joint part is suppressed, and the hardnesses of the head top portion and the web portion of the welded joint part are further increased. Therefore, in order to further increase the hardness of the welded joint part, it is preferable to control the cooling stop temperatures of the head top corner-side outer surface and the outer surface of the web portion in the second accelerated cooling S5 to 200° C. or lower. In addition, an upper limit of the cooling stop temperatures of the head top corner-side outer surface and the outer surface of the web portion is preferably 180° C. or 140° C.

The temperature control is preferably performed based on values obtained by measuring the temperature of the head top corner-side outer surface 1214 of the weld center A of the welded joint part and the temperature of the outer surface of the web portion using a radiation-type thermometer or a contact thermometer. In addition, the average heating rate and the average cooling rate can be controlled by adjusting the surface temperature and the elapsed time based on the temperature measurement.

Various conditions specified in the heat treatment method of the welded joint part of the flash-butt-welded rail according to the present embodiment have been described above. In the heat treatment method according to the present embodiment, the cooling method and the heating method for the welded joint part are not particularly limited as long as the above-described conditions are satisfied. A cooling method and a heating method can be appropriately adopted depending on a size of the welded joint part or the like. Hereinafter, suitable examples of the cooling method and the heating method of the welded joint part will be described.

### (1) Preferable Accelerated Cooling Method, Cooling Range, and Cooling Position of Flash-Butt-Welded Joint Part

First, a preferable accelerated cooling method of the flash-butt-welded joint part will be described. In the heat treatment method according to the present embodiment, the accelerated cooling method is not particularly limited in any of the first accelerated cooling S1 performed immediately after the flash butt welding and the second accelerated cooling S5 performed after the holding S4. A method of using air, mist, or the like as a cooling medium and spraying the cooling medium onto the welded joint part is preferably applied to selectively perform accelerated cooling on the heat-affected zone of the welded joint part.

In addition, any accelerated cooling needs to be applied to the re-γ portion of the heat-affected zone where the hardness is likely to decrease. In addition, the wear resistance, the fatigue damage resistance, and the breakage resistance are the characteristics of the head portion and the web portion of the welded rail. Therefore, the accelerated cooling is performed to improve the hardness and the microstructure of the head top portion and the web portion. Therefore, it is desirable to spray the cooling medium over the entire head top outer surface and the entire web outer surface in the welded joint part. In addition, in a case where the cooling medium is sprayed onto the head portion, the cooling medium may flow to the web portion, providing a sufficient cooling power and enabling control of the cooling rate. In such a case, the web portion may not be subjected to active accelerated cooling.

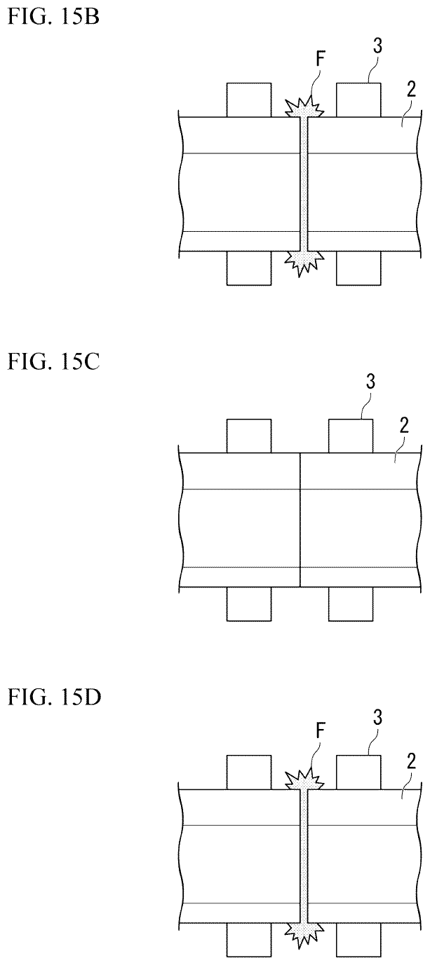

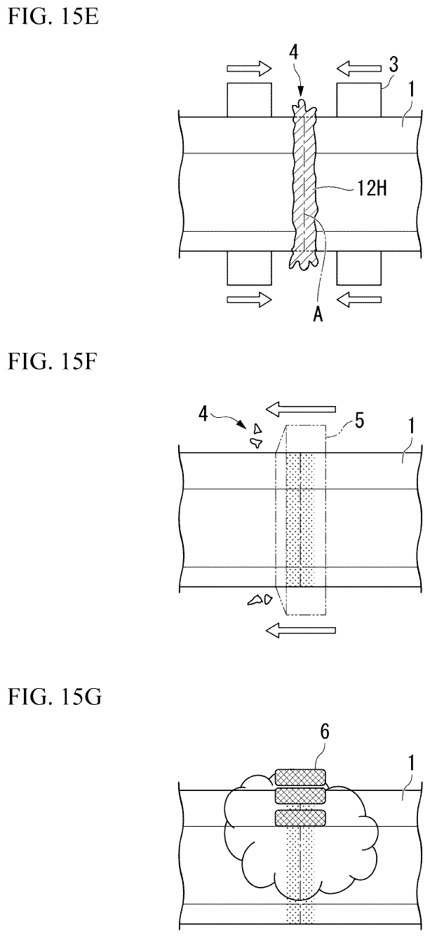

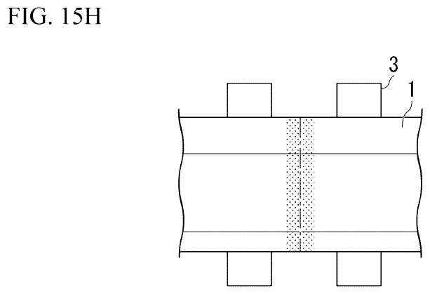

FIG. 15E shows a schematic view of an example of a cooling device 6. The cooling device 6 has a tubular shape and extends along the longitudinal direction of the welded rail 1. The cooling device 6 has a cooling gas discharge port facing the welded joint part of the welded rail. The cooling device 6 sprays a cooling gas onto a region including at least the heat-affected zone 12H (the tempered portion 12HT and the re-γ portion 12Hγ) to perform accelerated cooling of the welded joint part. In the schematic view of FIG. 15E, the cooling device 6 is disposed to spray the cooling gas onto the head top outer surface 1211, the head top corner-side outer surface 1214, and the fillet portion 1212 of the welded joint part, and the cooling gas is not directly sprayed onto the web portion 122. Since the cooling gas flows from the head portion to the web portion, the heat treatment conditions for the web outer surface described above can be achieved even in a case where the cooling device 6 is disposed as shown in FIG. 15E. Meanwhile, a cooling device 6 that blows a cooling gas onto the web portion may be further provided.

As described above, a temperature measurement position for controlling the accelerated cooling is desirably the head top corner-side outer surface 1214 of the weld center A (see FIG. 2) as a place representing the outer surface of the head portion.

### (2) Preferable Heating Method, Heating Range, and Control Position of Flash-Butt-Welded Joint Part

Next, a preferable heating method for the flash-butt-welded joint part will be described. In the heat treatment method according to the present embodiment, a method for performing the heating S3 is not particularly limited. High-frequency heating or energization heating with electrodes is desirable because the welded joint part can be selectively heated and the temperature thereof can be controlled.

In addition, it is preferable that the heating is performed on the inside of the head portion and the inside of the web portion of the welded joint part where the martensite structures are generated. That is, the heating is preferably performed on the outer surfaces of the head portion and the web portion of the welded joint part. In addition, the base portion may or may not be heated. In some cases, the welded joint part may be heated up to the base portion depending on the selection of the heating method. However, as long as the heating conditions are within the ranges described above, the characteristics of the welded joint part are not significantly affected, so the entire welded joint part may be heated.

FIG. 15F shows a schematic view of an example of the heating method. In FIG. 15F, the welded joint part is heated using electrodes 3 disposed on the head portion and the base portion to sandwich the rail portions. The electrode 3 is an electrode for flash butt welding (see schematic views of flash butt welding shown in FIGS. 15A to 15C). A manufacturing facility for a flash-butt-welded rail can be simplified by using the electrode for flash butt welding for the heat treatment of the welded joint part.

As described above, the temperature measurement position for controlling the heating is desirably the head top corner-side outer surface 1214 (see FIG. 2) of the weld center A as a place representing the outer surfaces of the head portion and the web portion. As a matter of course, the outer surfaces of the head side portion and the web portion may be controlled separately.

### (2. Production Method for Flash-Butt-Welded Joint)

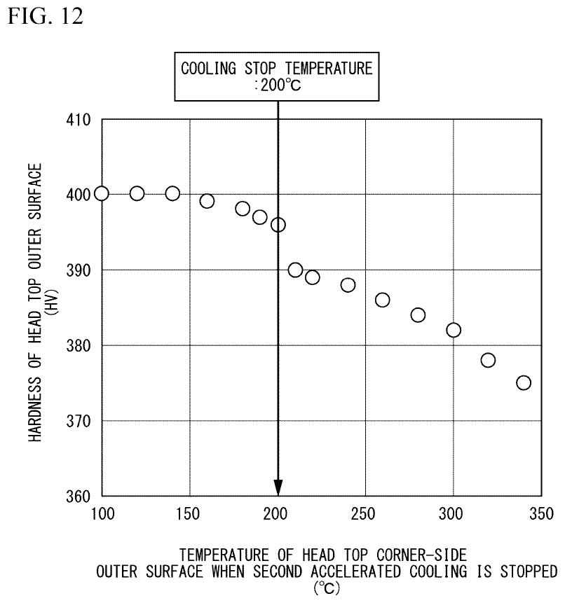

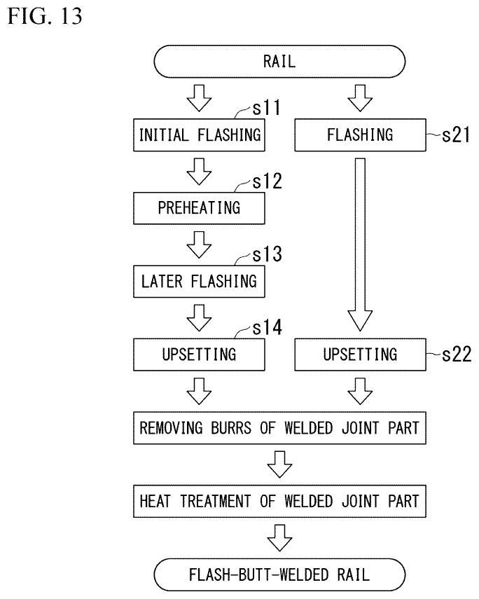

Next, a production method for a flash-butt-welded joint according to another aspect of the present invention will be described. The production method for a flash-butt-welded joint according to the present embodiment includes, as shown in a flowchart of FIG. 13, a step of performing flash butt welding on rails 2 to obtain the flash-butt-welded rail 1, a step of removing burrs from the welded joint part of the flash-butt-welded rail, and a step of performing a heat treatment on the flash-butt-welded rail 1 by the heat treatment method for a welded joint part of a flash-butt-welded rail according to the above-described embodiment.

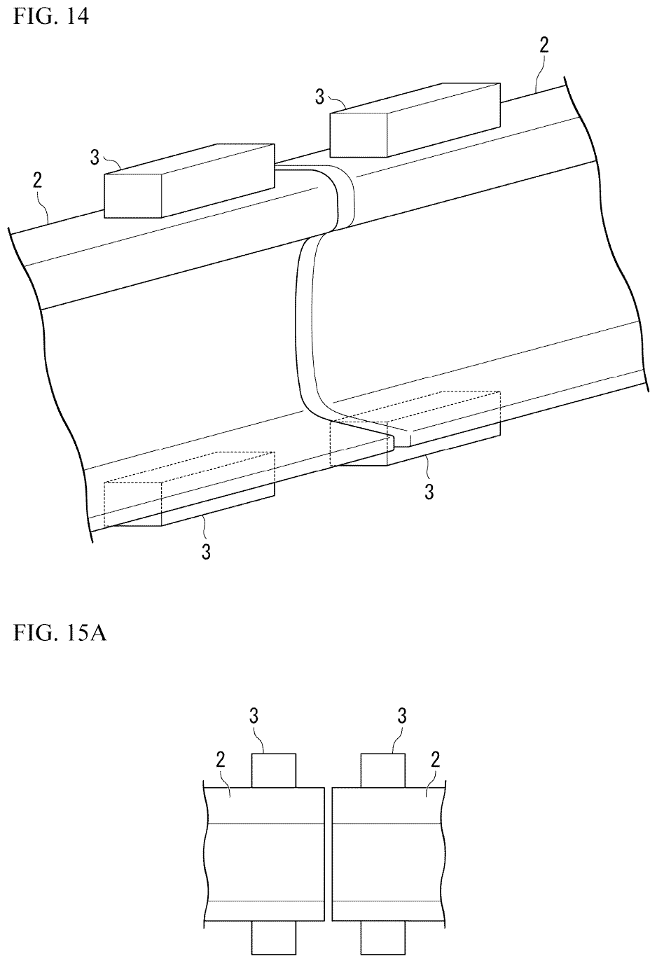

An outline of a suitable example of the production method for a flash-butt-welded joint is schematically shown in FIGS. 14, and 15A to 15H.

First, as shown in a perspective view of FIG. 14 and a side view of FIG. 15A, the electrodes 3 are attached to a pair of rails 2 before welding. The electrodes 3 are usually disposed to sandwich the head portion and the base portion of the rails.

Next, the rails 2 are subjected to flash butt welding. Specifically, as shown in FIG. 15B, the electrodes 3 are energized to generate a flash F in a space between end surfaces of the rails 2 (initial flashing step).

Next, as shown in FIG. 15C, a large current is caused to flow through the pair of rails 2 (rails serving as welding materials) for a certain period of time in a state in which contact surfaces are forcibly brought into contact with each other, and the base material near welding surface is preheated by resistance heating (preheating step). Furthermore, after the preheating, the rails 2 (rails serving as the welding materials) are separated from each other to form a space between the end surfaces of the rails 2 as shown in FIG. 15D, the electrodes 3 are energized to generate the flash F in the space between the end surfaces of the rails 2, and the melting of the end surfaces of the rails 2 is accelerated by the flash F (later flashing step).

At the end of the flash butt welding, the end surfaces of the pair of rails 2 are butted together and pressed against each other as shown in FIG. 15E. As a result, the pair of rails 2 are joined into the welded rail 1. During the pressing, molten metal is discharged to the outside of the welded joint part. This molten metal solidifies and becomes burrs 4 (upsetting step).

After the end of the flash butt welding, as shown in FIG. 15F, the burrs 4 are removed using a trimmer 5. The step of removing the burrs 4 may be referred to as trimming. In FIG. 15F, the trimer 5 is moved in a direction from the right to the left of the paper to remove the burrs 4. During the trimming, the electrodes 3 may be removed from the rails since the electrodes 3 may interfere with the operation.

In the schematic view of FIG. 15E, the burrs 4 are formed only on the top surface and the bottom surface of the welded rail 1, but the burrs 4 are actually formed on the side surface of the welded rail 1. In the schematic view of FIG. 15F, the trimmer 5 is disposed only on the top surface and the bottom surface of the welded rail 1, but in reality, the trimmer 5 is also disposed on the side surface of the welded rail 1 to remove the burrs 4 formed on the side surface of the welded rail 1.

Then, the heat treatment is performed on the welded rail 1. Specifically, first, as shown in FIG. 15G, the welded joint part is cooled using the cooling device 6 having the cooling gas discharge port facing the welded joint part. The cooling device 6 performs the first accelerated cooling on the welded joint part by spraying the cooling gas onto the welded joint part. Furthermore, as shown in FIG. 15H, the electrodes 3 are attached to the welded rail 1 again, and the welded joint part is subjected to energization heating. Preferably, after the end of the energization heating, the cooling device 6 is attached to the welded rail 1 again, and the second accelerated cooling is further performed.

A period from the end of the flash butt welding shown in FIG. 15E to the start of the cooling shown in FIG. 15G is preferably set to be about 60 seconds or shorter. In a welding facility of the present inventors, it was possible to shorten the period from the end of the flash butt welding to the start of the heat treatment to about 45 seconds by performing the removal of the electrodes 3, the trimming, and the attachment of the cooling device 6 quickly. In addition, when the trimming is performed, the temperature of the welded joint part decreases. However, in the welding facility of the present inventors, the temperature of the weld center A during the start of the heat treatment was 1000° C. or higher.

In the production method for a flash-butt-welded joint according to the present embodiment, the heat treatment is performed after flash butt welding in order to secure the hardness of the welded joint part and suppress the generation of martensite in the welded joint part. Therefore, according to the production method for a flash-butt-welded joint according to the present embodiment, it is possible to obtain a flash-butt-welded rail having excellent wear resistance and excellent breakage resistance.

Rails provided for flash butt welding and flash butt welding conditions are not particularly limited, but a preferable example will be described below.

### (1) Preferable Chemical Composition of Rail Steel

First, a preferable chemical composition of the rail steel constituting the rails to be subjected to welding will be described. In the heat treatment method according to the present embodiment, the chemical composition of the rail steel is not particularly limited. In order to secure a minimum limit of hardness or strength required for a rail, a component system that basically contains components including C: 0.75 to 1.20 mass %, Si: 0.10 to 2.00 mass %, and Mn: 0.20 to 2.00 mass %, and contains, as necessary, one or two or more elements of N: 0.020% or less, P: 0.025% or less, S: 0.025% or less, Cr: 0.05% to 2.00%, Mo: 0% to 0.50%, V: 0% to 0.100%, Nb: 0% to 0.0500%, B: 0% to 0.0050%, Co: 0% to 1.00%, Cu: 0% to 1.00%, Ni: 0% to 1.00%, Ti: 0% to 0.0500%, Mg: 0% to 0.0200%, Ca: 0% to 0.0200%, Al: 0% to 1.00%, Zr: 0% to 0.0200%, REM: 0% to 0.0500%, and a remainder including iron and impurities is desirable. The shape of the rail is not particularly limited. For example, the rail profile may be 115 to 140 pounds (57 to 70 kg/m).

### (2) Preferable HAZ Width and Flash Butt Welding Conditions for Welded Joint Part

Next, a preferable HAZ width and flash butt welding conditions for the welded joint part will be described. The HAZ is formed by flash butt welding. Therefore, the HAZ width is a value that depends on the flash butt welding conditions. The heat treatment after the flash butt welding changes the hardness, structure, and the like of the HAZ, but does not change the HAZ width.

In the heat treatment method according to the present embodiment, the HAZ width is not particularly limited, but it is desirable to set the HAZ width to be in a range of 10 to 40 mm. When the HAZ width is set to 10 mm or more, the amount of heat transferred from the welded joint part to the base material portion after the end of flash butt welding is reduced, and the generation of martensite structures in the inside of the head portion and the web portion of the welded joint part can be further suppressed. In addition, when the HAZ width is set to 40 mm or less, the hardness of the welded joint part can be further improved.

In addition, in a production method for a rail according to the present embodiment, the flash butt welding conditions are not particularly limited. For example, a welding method for controlling the HAZ width to the above-described preferable range of 10 to 40 mm is as follows.

Examples of flash butt welding of a rail include a preheating flash method and a continuous flash method. Any welding method can be applied to the production method for a welded rail according to the present embodiment.

In the case of the preheating flash method, the flash butt welding includes
(s11) an initial flashing step (see FIG. 15B),
(s12) a preheating step (see FIG. 15C),
(s13) a later flashing step (see FIG. 15D), and
(S14) an upsetting step (refer to FIG. 15E).
   (s11) Initial Flash Step

The initial flashing step is a flashing step that begins with a rail at room temperature. Specifically, first, as shown in FIG. 15B, the electrodes 3 are energized to generate the flash F in a space between the end surfaces of the rails 2. In the initial flash step, a flash is generated between the end surfaces (that is, the welding surfaces) of the pair of rails in order to facilitate contact of the welding surfaces in the subsequent preheating step. Accordingly, the welding surfaces are adjusted to be perpendicular to the longitudinal direction of the rail. Furthermore, in the initial flashing step, the welding surfaces are heated by resistance heating and arc heating of the flash. A time for which the initial flashing step is performed, that is, an initial flash time is desirably 10 seconds or longer and 40 seconds or shorter.

(s12) Preheating Step

In the preheating step, as shown in FIG. 15C, a large current is caused to flow through the pair of rails for a certain period of time in a state in which the welding surfaces of the pair of rails that oppose each other are forcibly brought into contact with each other. Accordingly, resistance heating occurs, thereby heating the base material near the welding surfaces. Thereafter, the rails forming the pair are separated from each other. Contact and separation of the welding surfaces are repeated one or more times. The number of times of preheating (contact and separation of the welding surfaces) is preferably set to 2 or more. The number of times of preheating is more preferably 4 times or more, and even more preferably 12 times or more.

(s13) Later Flashing Step

After the preheating, in the later flashing step, the rails (rails serving as the welding materials) are separated from each other to form a space between the end surface of the rail 2 as shown in FIG. 15D, the electrodes 3 are energized to generate the flash F in the space between the end surfaces of the rails 2, and the melting of the end surfaces of the rails 2 is accelerated by the flash F. In the later flashing step, first, a flash is partially generated between the opposing welding surfaces, and the welding surfaces are heated by resistance heating and arc heating of this flash. Then, in the later flashing step, a flash speed is increased. Accordingly, the flash that has been generated on a part of the welding surfaces is caused to be generated on the entire welding surfaces. The entire welding surfaces are uniformly heated by the resistance heating and the arc heating of the flash. Furthermore, in the later flashing step, oxides generated during the preheating step are scattered and reduced by the flash. The flash speed is a speed at which jigs holding the pair of rails are brought closer to each other.

As a time for which the later flashing step is performed, that is, a later flash time increases, the HAZ width of the welded joint part increases. In addition, when the flash speed in the later flashing step, that is, a later flash speed is increased, a heat distribution in the vicinity of the welding surfaces becomes steeper, and as a result, the HAZ width of the welded joint part is reduced. Therefore, it is desirable to set the later flash time to 10 seconds or longer and 30 seconds or shorter, an average later flash speed to 0.3 mm/sec or faster, and a later flash speed immediately before upsetting (for 3 seconds) to 0.5 mm/sec or faster. Here, the average later flash speed is an average flash speed in the entire later flashing step, and the later flash speed immediately before upsetting is an average flash speed for 3 seconds before the start of upsetting. In order to reliably reduce the HAZ width of the welded joint part, it is desirable that a later flash margin, that is, the amount of loss of the rail in the later flashing step is 10 mm or more.

### (S14) Upsetting Step

In the later flashing step, the entire welding surfaces are melted. In the subsequent upsetting step, as shown in FIG. 15E, the end surfaces of the pair of rails 2 are butted together and pressed against each other. That is, the welding surfaces are rapidly brought into close contact with each other at a large weld force, and most of the molten metal of the welding surfaces is discharged to the outside. Furthermore, in the upsetting step, a portion heated to a high temperature behind the welding surface is pressed and deformed, thereby forming a joint part. That is, a portion of the oxides generated during welding is discharged by the upsetting step, and oxides remaining in the welded joint part is made fine and dispersed. Accordingly, it is possible to reduce a probability that oxides remain on a joint surface as defects that impair bending performance. In addition, discharging most of the molten metal to the outside by the upsetting step contributes to reducing the HAZ width of the welded joint part. In order to reliably reduce the HAZ width of the welded joint part, it is desirable to set the upset load to 50 kN or more. The upset load is more preferably set to 65 kN or more.

In the case of the continuous flash method, the flash butt welding includes
(s21) a flashing step, and
(s22) an upsetting step.

Unlike the preheating flash method, flash butt welding in the continuous flash method does not include a preheating step.
(s21) In the flashing step, as a flash time increases, the HAZ width of the welded joint part increases. In addition, when a flash speed is increased, a heat distribution in the vicinity of the welding surfaces becomes steeper, and as a result, the HAZ width of the welded joint part is reduced. Therefore, it is desirable that the flash time is 150 seconds or longer and 250 seconds or shorter, and the flash speed is 0.10 mm/sec or faster.
(s22) The upsetting step in the case of the continuous flash method may be performed under the same conditions as the upsetting step in the case of the preheating flash method described above. In order to reliably reduce the HAZ width of the welded joint part, it is desirable to perform preheating by pulsed flashing or the like before the flashing step, reduce the flash time, and increase the flash speed.

In the upsetting step of the flash butt welding, the molten metal is discharged from the welded joint part. The molten metal discharged from the welded joint part solidifies and forms burrs in the welded joint part. In order to remove the burrs, the production method for the flash-butt-welded joint according to the present embodiment may include a step of removing the burrs from the welded joint part after the end of the flash butt welding and before the start of the heat treatment of the welded joint part. The burr removal is preferably performed for a short time, for example, within 60 seconds so as not to interfere with the heat treatment of the welded joint part.

### (3) Preferable Microstructure of Welded Joint Part

Next, a suitable microstructure of a preferable welded joint part in a welded rail obtained by the production method for a welded rail according to the present embodiment will be described. However, the following description does not limit the production method for a welded rail according to the present embodiment. The microstructure to be described below is an example of a microstructure that is provided in a welded joint part of a welded rail having excellent wear resistance, fatigue damage resistance, and breakage resistance.

Securing wear resistance is most important for the rail head portion that comes into contact with the wheel. As a result of the investigation of the relationship between the microstructure and the wear resistance, it was confirmed that the type of the microstructure of the head portion in the welded joint part is most preferably a pearlite structure. Therefore, it is desirable that the head portion (⅓h from the head top surface) of the welded joint part has a pearlite structure.

It should be noted that “h” means a height of the welded rail. For portions of the welded joint part other than the head portion, a microstructure other than a pearlite structure may be included as long as the strength and the ductility required for the rail can be secured.

### EXAMPLES

Effects of one aspect of the present invention will be described more specifically with reference to examples. Conditions in the examples are merely one example of conditions adopted to confirm the feasibility and effects of the present invention. The present invention is not limited to this one example of conditions. The present invention can adopt various conditions as long as the object of the present invention is achieved without departing from the gist of the present invention.

Rails having the compositions shown in the table and described below were manufactured, and flash butt welding was performed under the welding conditions described below to manufacture welded rails. Furthermore, the heat treatment of the welded joint part was performed under heat treatment conditions described below. The “holding time” shown in Table 2 is, in principle, a time during which the temperature of the head top corner-side outer surface 1214 of the weld center A was in a range of 620° C. to 670° C. However, in some of the experimental examples, the temperature holding was performed in a temperature range of lower than 620° C. or higher than 670° C. For these examples, the isothermal holding time at the maximum temperature was described in the column of “holding time”. In the column of “average heating rate”, the average heating rate between the heating start temperature and the holding highest temperature was described. In addition, the “holding highest temperature” shown in the table is the highest temperature of the head top corner-side outer surface when reheating is performed. In addition, the “heating start time” shown in the table is the time from the stop of the first accelerated cooling to the start of heating.

### Rail

Composition: 0.90% C, 0.50% Si, 0.80% Mn, 0.30% Cr, 0.0100% P, 0.0100% S, 0.0040% N, and impurities
Rail profile: 136 pounds (weight: 67 kg/m).
Hardness of the base material portion: 400 HV (measured at rail head top outer surface 1111, see FIG. 2)

### Flash Butt Welding Conditions (Preheating Flash Method)

Initial flash time: 20 seconds
Number of times of preheating: 10 times
Later flash time: 30 seconds
Average later flash speed: 0.6 mm/sec
Later flash speed immediately before upsetting (for 3 seconds): 1.4 mm/sec
Amount of loss of later flash: 10 mm
Upset load: 75 kN
HAZ width: 30 mm

### Heat Treatment Conditions for the Welded Joint Part

First Accelerated Cooling Conditions for the Welded Joint Part Immediately after Welding
Control position: The head top corner-side outer surface 1214 of the weld center A and the web outer surface 1221 (see FIG. 2)
Cooling method: Air is uniformly sprayed onto the head portion
Timing of start of cooling: When the temperatures of the head side outer surface and the web outer surface of the weld center A are in a range of 700° C. or higher
Average cooling rate in a temperature range of 750° C. to 600° C.: As shown in the “average cooling rate” column of Tables 1A and 1B. In Tables 1A and 1B, the average cooling rates of the head top corner-side outer surface and the web outer surface were described.

### Stop Condition for the First Accelerated Cooling

Stop temperature of the first accelerated cooling: As shown in the “cooling stop temperature” column of Tables 1A and 1B. In Tables 1A and 1B, the cooling stop temperatures of the head top corner-side outer surface and the web outer surface were described.

### Heating Conditions for the Welded Joint Part

Control position: The head top corner-side outer surface 1214 of the weld center A and the web outer surface 1221 (see FIG. 2)
Heating method: High-frequency heating is uniformly performed on the head portion
Average heating rate: As shown in the “average heating rate” column of Table 2. In all the examples, the average heating rates of the head top corner-side outer surface 1214 and the web outer surface 1221 were substantially the same.

### Temperature Holding Conditions for the Welded Joint Part

Holding temperature and holding time: As shown in the “holding highest temperature” column and the “holding time” column of Table 2. In all the examples, the holding temperatures and the holding times of the head top corner-side outer surface 1214 and the web outer surface 1221 were substantially the same.
   Second Accelerated Cooling Conditions after Heat Treatment
Control position: The head top corner-side outer surface 1214 of the weld center A and the web outer surface 1221 (see FIG. 2)
Cooling method: Air is uniformly sprayed onto the head portion (see FIG. 15E).
Timing of start of cooling: When the temperature of the head top corner-side outer surface 1214 of the weld center A is in a range of 600° C. or higher
Temperature measurement unit: Radiation-type thermometer

Average cooling rate and cooling stop temperature: As shown in the “average cooling rate” column and the “cooling stop temperature” column of Table 2. In all the examples, the average cooling rate and the cooling stop temperature in the head top corner-side outer surface 1214 and the web outer surface 1221 were substantially the same.

However, some of the welded rails were changed in heat treatment conditions for the above-described welded joint part or rail steel compositions. Changes in the rail steel compositions are shown in the “remarks” column of the tables. For example, in Example 29, “C: 1.20%” is described in the remarks column. In Example 29, the C content was 1.20%, and other chemical compositions were as described above.

The same applies to other examples.

In addition, the wear resistance of the flash-butt-welded joint part was evaluated by estimating the hardness characteristics of the welded joint part, which are highly correlated with the wear characteristics. When the absolute value of the difference in hardness between the welded joint part and the base material increased, it was evaluated that the unevenness due to wear increased and the wear resistance of the welded joint part decreased. An evaluation index of the wear resistance is as shown below.
Absolute value of difference in hardness between welded joint part and base material 0 to 10 HV Evaluation: A
Absolute value of difference in hardness between welded joint part and base material More than 10 to 20 HV Evaluation: B
Absolute value of difference in hardness between welded joint part and base material More than 20 to 30 HV Evaluation: C
Absolute value of difference in hardness between welded joint part and base material More than 30 HV Evaluation: X

In addition, the breakage resistance of the flash-butt-welded joint part was evaluated by determining the presence or absence of martensite structures in the welded joint part that causes breakage.
Generation of martensite in welded joint part Absent Evaluation: A
Generation of martensite in welded joint part Present Evaluation: X

The evaluation method for the hardness of the flash-butt-welded joint part and the evaluation method for the martensite structures are as described above.

TABLE 1A

| | | Average | |
|---|---|---|---|
| | | cooling | Cooling stop |
| | Control site | rate | temperature |
| 1 | Head top corner-side | 2.0 | 570 |
| | outer surface | | |
| | Web outer surface | 2.2 | 560 |
| 2 | Head top corner-side | 1.5 | 570 |
| | outer surface | | |
| | Web outer surface | 1.7 | 560 |
| 3 | Head top corner-side | 4.0 | 570 |
| | outer surface | | |
| | Web outer surface | 4.5 | 560 |
| 4 | Head top corner-side | 3.5 | 570 |
| | outer surface | | |
| | Web outer surface | 4.0 | 560 |
| 5 | Head top corner-side | 1.0 | 570 |
| | outer surface | | |
| | Web outer surface | 1.0 | 560 |
| 6 | Head top corner-side | 0.5 | 570 |
| | outer surface | | |
| | Web outer surface | 0.5 | 560 |
| 7 | Head top corner-side | 2.0 | 630 |
| | outer surface | | |
| | Web outer surface | 2.2 | 620 |
| 8 | Head top corner-side | 2.0 | 600 |
| | outer surface | | |
| | Web outer surface | 2.2 | 600 |
| 9 | Head top corner-side | 2.0 | 500 |
| | outer surface | | |
| | Web outer surface | 2.2 | 500 |
| 10 | Head top corner-side | 2.0 | 450 |
| | outer surface | | |
| | Web outer surface | 2.2 | 440 |
| 11 | Head top corner-side | 2.0 | 570 |
| | outer surface | | |
| | Web outer surface | 2.2 | 560 |
| 12 | Head top corner-side | 2.0 | 570 |
| | outer surface | | |
| | Web outer surface | 2.2 | 560 |
| 13 | Head top corner-side | 2.0 | 570 |
| | outer surface | | |
| | Web outer surface | 2.2 | 560 |
| 14 | Head top corner-side | 2.0 | 570 |
| | outer surface | | |
| | Web outer surface | 2.2 | 560 |
| 15 | Head top corner-side | 2.0 | 570 |
| | outer surface | | |
| | Web outer surface | 2.2 | 560 |
| 16 | Head top corner-side | 2.0 | 570 |
| | outer surface | | |
| | Web outer surface | 2.2 | 560 |
| 17 | Head top corner-side | 2.0 | 570 |
| | outer surface | | |
| | Web outer surface | 2.2 | 560 |
| 18 | Head top corner-side | 2.0 | 570 |
| | outer surface | | |
| | Web outer surface | 2.2 | 560 |

TABLE 1B

| | | Average | |
|---|---|---|---|
| | | cooling | Cooling stop |
| | Control site | rate | temperature |
| 19 | Head top corner-side | 2.0 | 570 |
| | outer surface | | |
| | Web outer surface | 2.2 | 560 |
| 20 | Head top corner-side | 2.0 | 570 |
| | outer surface | | |
| | Web outer surface | 2.2 | 560 |
| 21 | Head top corner-side | 2.0 | 570 |
| | outer surface | | |
| | Web outer surface | 2.2 | 560 |
| 22 | Head top corner-side | 2.0 | 570 |
| | outer surface | | |
| | Web outer surface | 2.2 | 560 |
| 23 | Head top corner-side | 2.0 | 570 |
| | outer surface | | |
| | Web outer surface | 2.2 | 560 |
| 24 | Head top corner-side | 2.0 | 570 |
| | outer surface | | |
| | Web outer surface | 2.2 | 560 |
| 25 | Head top corner-side | 2.0 | 570 |
| | outer surface | | |
| | Web outer surface | 2.2 | 560 |
| 26 | Head top corner-side | 2.0 | 570 |
| | outer surface | | |
| | Web outer surface | 2.2 | 560 |
| 27 | Head top corner-side | 2.0 | 570 |
| | outer surface | | |
| | Web outer surface | 2.2 | 560 |
| 28 | Head top corner-side | 2.0 | 570 |
| | outer surface | | |
| | Web outer surface | 2.2 | 560 |
| 29 | Head top corner-side | 2.0 | 570 |
| | outer surface | | |
| | Web outer surface | 2.2 | 560 |
| 30 | Head top corner-side | 2.0 | 570 |
| | outer surface | | |
| | Web outer surface | 2.2 | 560 |
| 31 | Head top corner-side | 2.0 | 570 |
| | outer surface | | |
| | Web outer surface | 2.2 | 560 |
| 32 | Head top corner-side | 2.0 | 570 |
| | outer surface | | |
| | Web outer surface | 2.2 | 560 |
| 33 | Head top corner-side | 2.0 | 570 |
| | outer surface | | |
| | Web outer surface | 2.2 | 560 |
| 34 | Head top corner-side | 2.0 | 570 |
| | outer surface | | |
| | Web outer surface | 2.2 | 560 |
| 35 | Head top corner-side | 2.0 | 570 |
| | outer surface | | |
| | Web outer surface | 2.2 | 560 |
| 36 | Head top corner-side | 2.0 | 570 |
| | outer surface | | |
| | Web outer surface | 2.2 | 560 |

TABLE 2

| | Heating | Average | Holding | | Average | Cooling | | | |
|---|---|---|---|---|---|---|---|---|---|
| | start | heating | highest | Holding | cooling | stop | | | |
| | time | rate | temperature | time | rate | temperature | Fracture | Wear | |
| | sec | ° C./sec | ° C. | sec | ° C./sec | ° C. | resistance | resistance | Remark |
| 1 | 80 | 1.5 | 630 | 80 | 1.0 | 120 | A | A | |
| 2 | — | — | — | — | — | — | X | A | |
| 3 | 80 | 1.5 | 630 | 80 | 1.0 | 120 | A | X | |
| 4 | 80 | 1.5 | 630 | 80 | 1.0 | 120 | A | B | |
| 5 | 80 | 1.5 | 630 | 80 | 1.0 | 120 | A | B | |
| 6 | 80 | 1.5 | 630 | 80 | 1.0 | 120 | A | X | |
| 7 | 80 | 1.5 | 630 | 80 | 1.0 | 120 | A | X | |
| 8 | 80 | 1.5 | 630 | 80 | 1.0 | 120 | A | B | |
| 9 | 80 | 1.5 | 630 | 80 | 1.0 | 120 | A | A | |
| 10 | 80 | 1.5 | 630 | 80 | 1.0 | 120 | X | A | |
| 11 | 400 | 1.5 | 630 | 80 | 1.0 | 120 | X | A | |
| 12 | 300 | 1.5 | 630 | 80 | 1.0 | 120 | A | A | |
| 13 | 80 | 3.0 | 630 | 80 | 1.0 | 120 | X | A | |
| 14 | 80 | 2.0 | 630 | 80 | 1.0 | 120 | A | A | |
| 15 | 80 | 0.5 | 630 | 80 | 1.0 | 120 | A | B | |
| 16 | 80 | 0.2 | 630 | 80 | 1.0 | 120 | A | X | |
| 17 | 80 | 1.5 | 700 | 80 | 1.0 | 120 | A | X | |
| 18 | 80 | 1.5 | 670 | 80 | 1.0 | 120 | A | B | |
| 19 | 80 | 1.5 | 620 | 80 | 1.0 | 120 | A | A | |
| 20 | 80 | 1.5 | 600 | 80 | 1.0 | 120 | X | A | |
| 21 | 80 | 1.5 | 630 | 200 | 1.0 | 120 | A | X | |
| 22 | 80 | 1.5 | 630 | 180 | 1.0 | 120 | A | B | |
| 23 | 80 | 1.5 | 630 | 30 | 1.0 | 120 | A | A | |
| 24 | 80 | 1.5 | 630 | 10 | 1.0 | 120 | X | A | |
| 25 | 80 | 1.5 | 630 | 80 | 0.5 | 120 | A | B | |
| 26 | 80 | 1.5 | 630 | 80 | 0.2 | 120 | A | C | |
| 27 | 80 | 1.5 | 630 | 80 | 1.0 | 300 | A | C | |
| 28 | 80 | 1.5 | 630 | 80 | 1.0 | 200 | A | B | |
| 29 | 80 | 1.5 | 630 | 80 | 1.0 | 120 | A | A | C: 1.20% |
| 30 | 80 | 1.5 | 630 | 80 | 1.0 | 120 | A | A | C: 0.75% |
| 31 | 80 | 1.5 | 630 | 80 | 1.0 | 120 | A | C | Si: 0.10% |
| 32 | 80 | 1.5 | 630 | 80 | 1.0 | 120 | A | A | Si: 2.00% |
| 33 | 80 | 1.5 | 630 | 80 | 1.0 | 120 | A | C | Mn: 0.20% |
| 34 | 80 | 1.5 | 630 | 80 | 1.0 | 120 | A | A | Mn: 2.00% |
| 35 | 80 | 1.5 | 630 | 80 | 1.0 | 120 | A | B | Cr: 0.05% |
| 36 | 80 | 1.5 | 630 | 80 | 1.0 | 120 | A | A | Cr: 0.40% |

In Example 2, heating was not performed after the first accelerated cooling S1. As a result, in Example 2, martensite was generated in the welded joint part, and the breakage resistance was insufficient.

In Example 3, the average cooling rates of the head top corner-side outer surface and the web outer surface in the first accelerated cooling S1 were excessive. As a result, in Example 3, the hardness of the welded joint part was excessive, the difference in hardness between the rail portion and the welded joint part was excessive, and the wear resistance was insufficient.

In Example 6, the average cooling rates of the head top corner-side outer surface and the web outer surface in the first accelerated cooling S1 were insufficient. As a result, in Example 6, the hardness of the welded joint part was insufficient, the difference in hardness between the rail portion and the welded joint part was excessive, and the wear resistance was insufficient.

In Example 7, the stop temperature of the first accelerated cooling S1 was too high in the head top corner-side outer surface and the web outer surface. As a result, in Example 7, the hardness of the welded joint part was insufficient, the difference in hardness between the rail portion and the welded joint part was excessive, and the wear resistance was insufficient.

In Example 10, the stop temperature of the first accelerated cooling S1 was too low in the head top corner-side outer surface and the web outer surface. As a result, in Example 10, martensite was generated in the welded joint part, and the breakage resistance was insufficient. This martensite is presumed to have been generated during the first accelerated cooling S1.

In Example 11, the time from the stop of the first accelerated cooling S1 to the start of the heating S3 was too long. As a result, in Example 11, martensite was generated in the welded joint part, and the breakage resistance was insufficient. This martensite is presumed to have been generated before the start of the heating S3 after the first accelerated cooling S1.

In Example 13, the average heating rate in the heating S3 was excessive. As a result, in Example 13, martensite was generated in the welded joint part, and the breakage resistance was insufficient. This is presumed to be because the temperature of the inside of the head portion of the welded joint part did not sufficiently rise and the pearlitic transformation was not promoted.

In Example 16, the average heating rate in the heating S3 was insufficient. As a result, in Example 16, the hardness of the welded joint part was insufficient, the difference in hardness between the rail portion and the welded joint part was excessive, and the wear resistance was insufficient. This is presumed to be because the welded joint part was tempered.

In Example 17, the holding highest temperature in the holding S4 was too high. As a result, in Example 17, the hardness of the welded joint part was insufficient, the difference in hardness between the rail portion and the welded joint part was excessive, and the wear resistance was insufficient. This is presumed to be because the welded joint part was tempered.

In Example 20, the temperature at the end of the temperature rise, that is, the holding temperature in the holding S4 was too low. As a result, in Example 20, martensite was generated in the welded joint part, and the breakage resistance was insufficient. This is presumed to be because the pearlitic transformation rate significantly decreased and the pearlitic transformation was not completed.

In Example 21, the holding time in the holding S4 was excessive. As a result, in Example 21, the hardness of the welded joint part was insufficient, the difference in hardness between the rail portion and the welded joint part was excessive, and the wear resistance was insufficient. This is presumed to be because the welded joint part was tempered.

In Example 24, the holding time in the holding S4 was insufficient. As a result, in Example 24, martensite was generated in the welded joint part, and the breakage resistance was insufficient. This is presumed to be because the pearlitic transformation was not completed within the holding time.

Meanwhile, in the welded rails obtained by the production method to which the heat treatment method according to the present embodiment was applied, both the breakage resistance and the wear resistance of the welded joint part were excellent.

### REFERENCE SIGNS LIST

S1 First accelerated cooling
S2 Stop of first accelerated cooling
S3 Heating
S4 Holding
S5 Second accelerated cooling
1 Flash-butt-welded rail (welded rail)
11 Rail portion
111 Rail head portion
1111 Rail head top outer surface
1112 Rail fillet portion
1113 Rail head side outer surface
1114 Rail head top corner-side outer surface
112 Rail web portion
1121 Rail web outer surface
113 Rail base portion
12 Welded joint part
121 Head portion (of welded joint part)
1211 Head top outer surface (of welded joint part)
1212 Fillet portion (of welded joint part)
1213 Head side outer surface (of welded joint part)
1214 Head top corner-side outer surface (of welded joint part)
122 Web portion (of welded joint part)
1221 Web outer surface (of welded joint part)
123 Base portion (of welded joint part)
12H Heat-affected zone (HAZ)
12HT Tempered portion
12Hγ Re-γ portion
A Weld center
B Martensite evaluation region
2 Rail before welding
3 Electrode
4 Burrs
5 Trimmer
6 Cooling device
F Flash

1. A heat treatment method for a welded joint part of a flash-butt-welded rail, the method comprising:
performing, after flash butt welding in a flash-butt-welded rail having a welded joint part is ended, first accelerated cooling on the welded joint part;
stopping the first accelerated cooling;
heating the welded joint part; and
holding a temperature of the welded joint part,
wherein the first accelerated cooling is started when temperatures of a head top corner-side outer surface and a web outer surface in a weld center of the welded joint part are in a range of 700° C. or higher,
in the first accelerated cooling, an average cooling rate in a temperature range of 750° C. to 600° C. of the head top corner-side outer surface in the weld center of the welded joint part is set to 1.0 to 3.5° C./sec,
in the first accelerated cooling, an average cooling rate in a temperature range of 750° C. to 600° C. of the web outer surface in the weld center of the welded joint part is set to 1.0 to 4.0° C./sec,
the first accelerated cooling is stopped when the temperature of the head top corner-side outer surface and the temperature of the web outer surface in the weld center of the welded joint part are in a range of 500° C. to 600° C.,
the heating is started within 300 seconds after the stop of the first accelerated cooling,
in the heating, an average heating rate of the head top corner-side outer surface and an average heating rate of the web outer surface in the weld center of the welded joint part are set to 0.5 to 2.0° C./sec, and
in the holding, the temperature of the head top corner-side outer surface and the temperature of the web outer surface in the weld center of the welded joint part are held in a range of 620° C. to 670° C. for 30 to 180 seconds.

2. The heat treatment method for a welded joint part of a flash-butt-welded rail according to claim 1, further comprising:
performing second accelerated cooling on the welded joint part such that the head top corner-side outer surface and the web outer surface in the weld center of the welded joint part are cooled to 200° C. or lower at an average cooling rate of 0.5° C./sec or faster after the holding of the temperature of the welded joint part.

3. A production method for a flash-butt-welded rail, the production method comprising:
performing flash butt welding on rails to obtain a flash-butt-welded rail;
removing burrs from a welded joint part of the flash-butt-welded rail; and
performing a heat treatment on the flash-butt-welded rail using a heat treatment method for a welded joint part of a flash-butt-welded rails, the heat treatment method comprising:
performing, after flash butt welding in a flash-butt-welded rail having a welded joint part is ended, first accelerated cooling on the welded joint part;
stopping the first accelerated cooling;
heating the welded joint part; and
holding a temperature of the welded joint part,
wherein the first accelerated cooling is started when temperatures of a head top corner-side outer surface and a web outer surface in a weld center of the welded joint part are in a range of 700° C. or higher,
in the first accelerated cooling, an average cooling rate in a temperature range of 750° C. to 600° C. of the head top corner-side outer surface in the weld center of the welded joint part is set to 1.0 to 35° C./s,
in the first accelerated cooling, an average cooling rate in a temperature range of 750′C to 600° C. of the web outer surface in the weld center of the welded joint part is set to 1.0 to 4.0° C./s,
the first accelerated cooling is stopped when the temperature of the head top corner-side outer surface and the temperature of the web outer surface in the weld center of the welded joint part are in a ran e of 500° C. to 600° C.,
the heating is started within 300 seconds after the stop of the first accelerated cooling,
in the heating, an average heating rate of the head too corner-side outer surface and an average heating rate of the web outer surface in the weld center of the welded joint part are set to 0.5 to 2.0° C./s, and
in the holding, the temperature of the head top corner-side outer surface and the temperature of the web outer surface in the weld center of the welded joint part are held in a range of 620° C. to 670° C. for 30 to 180 seconds.

4. The production method for a flash-butt-welded rail according to claim 3, further comprising:
performing second accelerated cooling on the welded joint part such that the head top corner-side outer surface and the web outer surface in the weld center of the welded joint part are cooled to 200° C. or lower at an average cooling rate of 0.5° C./s or faster after the holding of the temperature of the welded joint part.
